(19) United States
(12) Patent Application Publication
(10) Pub. No.: US 2015/0152756 A1
(43) Pub. Date: Jun. 4, 2015

(54) VARIABLE VALVE ACTUATION APPARATUS FOR MULTI-CYLINDER INTERNAL COMBUSTION ENGINE AND CONTROLLER FOR THE VARIABLE VALVE ACTUATION APPARATUS

(71) Applicant: HITACHI AUTOMOTIVE SYSTEMS, LTD., Hitachinaka-shi (JP)

(72) Inventor: Makoto NAKAMURA, Zushi-shi (JP)

(73) Assignee: HITACHI AUTOMOTIVE SYSTEMS, LTD., Hitachinaka-shi (JP)

(21) Appl. No.: 14/556,813

(22) Filed: Dec. 1, 2014

(30) Foreign Application Priority Data
Dec. 2, 2013 (JP) 2013-248807

(51) Int. Cl. F01L 13/00; F02D 17/02

(52) U.S. Cl. CPC F01L 13/0005; F01L 13/0015; F02D 17/02; F01L 2013/001

(57) ABSTRACT

A variable valve actuation apparatus for a multi-cylinder internal combustion engine employs a cylinder cutoff mechanism configured to enable intake and exhaust valves of a #1-cylinder to be kept inactive, and an intake-side variable valve lift mechanism configured to enable a valve lift amount of each of intake valves of a #2-cylinder to be switched between a given first lift amount created by a small-lift cam profile and a given second lift amount created by a middle-lift cam profile in a stepwise fashion depending on a change in engine operating condition from startup to maximum torque operation. The intake-side variable valve lift mechanism is further configured to enable the valve lift amount of each of the intake valves of the #2-cylinder to be selected from the given first lift amount and the given second lift amount during a cylinder cutoff mode in which the #1-cylinder is kept inactive.

### TECHNICAL FIELD

The present invention relates to a variable valve actuation apparatus for a multi-cylinder internal combustion engine capable of improving fuel economy by shifting or switching to a cylinder cutoff mode (or a partly-inactive cylinder operating mode or a cylinder-in-part operating mode) in which intake and exhaust valves included in one engine-cylinder group are kept inactive and intake and exhaust valves included in the other engine-cylinder group are kept active.

### BACKGROUND ART

In recent years, there have been proposed and developed various variable valve actuation apparatus for multi-cylinder internal combustion engines configured to enable mode-switching between (i) a full-cylinder operating mode (an all-cylinder operating mode or an all-cylinder active mode) and (ii) a cylinder cutoff mode (or a partly-inactive cylinder operating mode or a cylinder-in-part operating mode). Such variable valve actuation apparatus for multi-cylinder internal combustion engines capable of executing a cylinder cutoff mode have been disclosed in Japanese Patent Provisional Publication No. 10-82334 (hereinafter referred to as “JP10-82334”), Japanese Patent Provisional Publication No. 2000-179366 (hereinafter referred to as “JP2000-179366”), and Japanese Patent Provisional Publication No. 2004-316571 (hereinafter referred to as “JP2004-316571”).

For instance, a variable valve actuation apparatus, disclosed in JP10-82334, is configured to execute a cylinder cutoff mode (or a partly-inactive cylinder operating mode) at which intake and exhaust valves included in half of cylinders (i.e., engine cylinders arranged in the right bank of two banks) are inactive, while all the others (i.e., engine cylinders arranged in the left cylinder bank) are active or working (combusting). Such a cylinder cutoff mode contributes to a relatively increased throttle-valve opening, that is, a reduced pumping loss, and further contributes to the improvement of a load per working engine cylinder. The improved load per working engine cylinder (i.e., such a shift to high load), enhances a thermal efficiency, thus improving fuel economy.

A variable valve actuation (VVA) apparatus, disclosed in JP2000-179366, is configured to enable mode-switching between a cylinder cutoff mode and a full-cylinder operating mode. Additionally, in the full-cylinder operating range, the VVA apparatus of JP2000-179366 is also configured to perform a selected one of a small intake-valve lift characteristic mode (i.e., low-speed valve timing) and a large intake-valve lift characteristic mode (i.e., high-speed valve timing).

A variable valve actuation apparatus, disclosed in JP2004-316571, is configured such that a valve lift amount can be continuously varied for each engine-cylinder group, thereby reducing a torque shock occurring during a transition to a partly-inactive cylinder operating mode or during return from the partly-inactive cylinder operating mode to a full-cylinder operating mode.

### SUMMARY OF THE INVENTION

However, in the variable valve actuation apparatus, disclosed in JP10-82334, an intake-valve lift of the working cylinder, which is kept active during a cylinder cutoff mode (a partly-inactive cylinder operating mode), is fixed. Thus, there is a limit to fuel-consumption reducing effect in a partly-inactive cylinder operating range. That is, on the low-torque side in the partly-inactive cylinder operating range, there is a tendency for the throttle-valve opening to be reduced to a certain extent so as to reduce the engine torque. Thus, even under the partly-inactive cylinder operating condition, a pumping loss tends to be increased to a certain extent, and hence a fuel-consumption reducing effect is inhibited. Conversely on the high-torque side in the partly-inactive cylinder operating range, the engine torque cannot be sufficiently increased and thus it is impossible to satisfactorily enlarge the partly-inactive cylinder operating range, in which fuel economy can be improved, toward the high engine-torque side. Therefore, in a practical operating range, the frequency of the partly-inactive cylinder operating mode cannot be sufficiently increased. For the reasons discussed above, it is impossible to sufficiently enhance the fuel consumption performance during actual driving of the vehicle.

In the variable valve actuation apparatus, disclosed in JP2000-179366, owing to a large number of switching mechanisms required for mode-switching between a full-cylinder operating mode and a cylinder cutoff mode (a partly-inactive cylinder operating mode), the mode-switching system itself is very complicated. In a similar manner to the VVA apparatus of JP10-82334, also in the case of the VVA apparatus of JP2000-179366, an intake-valve lift of the working cylinder, which is kept active during a cylinder cutoff mode (a partly-inactive cylinder operating mode), is fixed. Thus, there is a limit to fuel-consumption reducing effect in a partly-inactive cylinder operating range.

Also, in the variable valve actuation apparatus, disclosed in JP2004-316571, an intake-valve lift of the working cylinder, which is kept active during a cylinder cutoff mode (a partly-inactive cylinder operating mode), is fixed. Therefore, the VVA apparatus of JP2004-316571 has the same drawback as JP10-82334. That is, there is a limit to fuel-consumption reducing effect in a partly-inactive cylinder operating range. Furthermore, the VVA apparatus of JP2004-316571, which is configured such that a valve lift amount can be continuously varied for each cylinder group, has another drawback. Concretely, there is an increased tendency for a deviation between valve lifts of different cylinder groups to undesirably occur. This leads to the problems, that is, an increase of control load required to stabilize a valve lift (a controlled variable) and a very complicated VVA system.

Accordingly, it is an object of the invention to provide a variable valve actuation apparatus for a multi-cylinder internal combustion engine configured to more greatly improve fuel economy during a cylinder cutoff mode (a partly-inactive cylinder operating mode), in which a first cylinder group (an inactive cylinder group) is placed into an inactive state and a second cylinder group (a working cylinder group) remains kept active, by multistage-changing an intake-valve lift of the working cylinder group in a mode-transition between the cylinder cutoff mode and a full-cylinder operating mode.

In order to accomplish the aforementioned and other objects of the present invention, a variable valve actuation apparatus for a multi-cylinder internal combustion engine comprises a cylinder cutoff mechanism configured to enable a cylinder cutoff mode in which intake and exhaust valves included in one engine-cylinder group of a plurality of engine-cylinder groups are kept inactive, and an intake-side variable valve lift mechanism configured to enable a valve lift amount of each of intake valves included in the other engine-cylinder group of the plurality of engine-cylinder groups to be switched between a given first intake-valve lift amount and a given second intake-valve lift amount relatively greater than the given first intake-valve lift amount in a stepwise fashion, wherein the intake-side variable valve lift mechanism is configured to enable the valve lift amount of each of the intake valves of the other engine-cylinder group to be selected from the given first intake-valve lift amount and the given second intake-valve lift amount during the cylinder cutoff mode in which the one engine-cylinder group is kept inactive.

According to another aspect of the invention, a controller for a variable valve actuation apparatus for a multi-cylinder internal combustion engine, comprises an input-and-output interface section configured to receive sensor signals for determining an engine operating condition, and a control section configured to control, depending on the engine operating condition, operation of a cylinder cutoff mechanism that enables a cylinder cutoff mode in which intake and exhaust valves included in one engine-cylinder group of a plurality of engine-cylinder groups are kept inactive, and control, depending on the engine operating condition, operation of an intake-side variable valve lift mechanism that enables a valve lift amount of each of intake valves included in the other engine-cylinder group of the plurality of engine-cylinder groups to be switched between a given first intake-valve lift amount and a given second intake-valve lift amount relatively greater than the given first intake-valve lift amount in a stepwise fashion, wherein the controller is configured to generate a control current for selectively switching between the given first intake-valve lift amount and the given second intake-valve lift amount via the intake-side variable valve lift mechanism, during the cylinder cutoff mode in which the one engine-cylinder group is kept inactive.

The other objects and features of this invention will become understood from the following description with reference to the accompanying drawings.

### BRIEF DESCRIPTION OF THE DRAWINGS

FIG. 1 is a schematic system diagram illustrating a system configuration of the first embodiment of a variable valve actuation (VVA) apparatus for a multi-cylinder internal combustion engine according to the present invention.

FIG. 2A is an explanatory view, partly in cross section, illustrating the operation of a cylinder cutoff mechanism on the intake-valve side (on the exhaust-valve side) during a zero-lift control mode, whereas FIG. 2B is an explanatory view, partly in cross section, illustrating the operation of the cylinder cutoff mechanism during a middle-lift control mode.

FIG. 3A is an explanatory view, partly in cross section, illustrating the operation of an intake-side variable valve lift (VVL) mechanism during a small-lift control mode, whereas FIG. 3B is an explanatory view, partly in cross section, illustrating the operation of the intake-side VVL mechanism during a middle-lift control mode.

FIG. 4 is a variable valve actuation system control map used by a controller for the VVA apparatus of the first embodiment, in a coordinate system in which an x-axis represents engine speed and a y-axis represents engine torque.

FIG. 5 is a characteristic diagram illustrating valve lift characteristics of intake and exhaust valves and throttle-valve opening characteristics in a full-cylinder operating mode and in a partly-inactive cylinder operating mode in the first embodiment.

FIG. 6 is an operating-mode-switching sequence chart in a transition from an “A” range (an initial operating range) of various engine-operating ranges shown on the control map of FIG. 4 to a “B” range.

FIG. 7 is a flowchart illustrating a control flow executed within the controller in the presence of a transition from the “A” range of the engine-operating ranges shown on the control map of FIG. 4 to the “B” range.

FIG. 8 is a variable valve actuation system control map used by a controller for the VVA apparatus of the second embodiment, in a coordinate system in which an x-axis represents engine speed and a y-axis represents engine torque.

FIG. 9 is a characteristic diagram illustrating valve lift characteristics of intake and exhaust valves and throttle-valve opening characteristics in a full-cylinder operating mode and in a partly-inactive cylinder operating mode in the second embodiment.

FIG. 10 is a schematic system diagram illustrating a system configuration of the third embodiment of a variable valve actuation (VVA) apparatus for a multi-cylinder internal combustion engine.

FIG. 11 is a characteristic diagram illustrating valve lift characteristics of intake and exhaust valves and throttle-valve opening characteristics in a full-cylinder operating mode and in a partly-inactive cylinder operating mode in the third embodiment.

FIG. 12A is an explanatory view, partly in cross section, illustrating the operation of a #2-cylinder intake-side VVL mechanism of the fourth embodiment with a sub-rocker arm operated at a lost-motion state, whereas FIG. 12B is an explanatory view, partly in cross section, illustrating the operation of the #2-cylinder intake-side VVL mechanism with the sub-rocker arm held at a stationary state.

FIG. 13 is a characteristic diagram illustrating valve lift characteristics of intake and exhaust valves and throttle-valve opening characteristics in a full-cylinder operating mode and in a partly-inactive cylinder operating mode in the fourth embodiment.

FIG. 14 is a perspective view illustrating an intake-side cylinder cutoff mechanism and an intake-side variable valve lift mechanism incorporated in the VVA apparatus of the fifth embodiment.

FIG. 15A is a longitudinal cross-sectional view illustrating a locked lash-adjuster-body state (in other words, an active (working) valve state) of a hydraulic lash adjuster serving as a cylinder cutoff mechanism in the fifth embodiment, whereas FIG. 15B is a longitudinal cross-sectional view illustrating a lash-adjuster-body lost-motion state (in other words, an inactive or stopped valve state) of the hydraulic lash adjuster.

FIG. 16 is a variable valve actuation system control map used by a controller for the VVA apparatus of the sixth embodiment, in a coordinate system in which an x-axis represents engine speed and a y-axis represents engine torque.

FIG. 17 is a characteristic diagram illustrating valve lift characteristics of intake and exhaust valves and throttle-valve opening characteristics in a full-cylinder operating mode and in a partly-inactive cylinder operating mode in the sixth embodiment.

### DESCRIPTION OF THE PREFERRED EMBODIMENTS

Respective embodiments of a variable valve actuation (VVA) apparatus for a multi-cylinder internal combustion engine are hereinafter described in detail with reference to the drawings. In the shown embodiments, the VVA apparatus is exemplified in an in-line two-cylinder gasoline internal combustion engine.

### First Embodiment

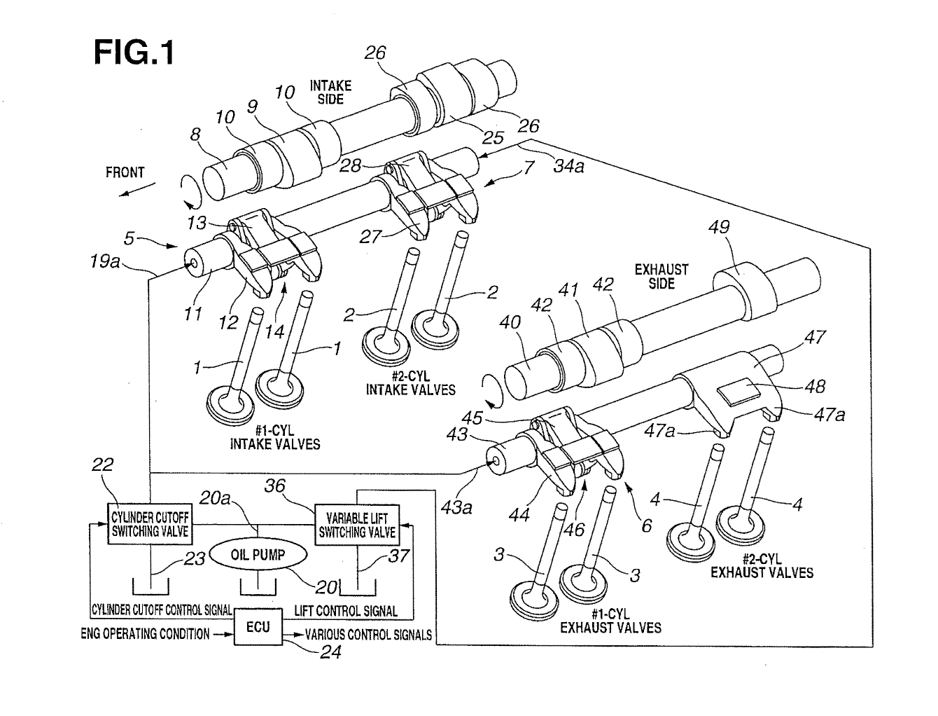

Referring now to FIG. 1, there is shown the VVA apparatus of the first embodiment. As shown in FIG. 1, two intake valves 1, 1 are arranged in a cylinder head of the #1-cylinder on the intake side, two intake valves 2, 2 are arranged in a cylinder head of the #2-cylinder on the intake side, two exhaust valves 3, 3 are arranged in the cylinder head of the #1-cylinder on the exhaust side, and two exhaust valves 4, 4 are arranged in the cylinder head of the #2-cylinder on the exhaust side.

Regarding the #1-cylinder side, a cylinder cutoff mechanism 5 is provided for stopping the operation of each of intake valves 1, 1, and a cylinder cutoff mechanism 6 is provided for stopping the operation of each of exhaust valves 3, 3, depending on an engine operating condition. Regarding the #2-cylinder side, an intake-side variable valve lift (VVL) mechanism 7 is provided for variably control or adjust a valve lift amount of each of intake valves 2, 2 in a stepwise fashion. Also, regarding the #2-cylinder side, a middle-lift cam 49 (described later) and a swing arm 47 are provided to create a fixed (constant) valve lift characteristic of each of exhaust valves 4, 4.

The intake-side cylinder cutoff mechanism 5 and the exhaust-side cylinder cutoff mechanism 6 are similar to each other in construction. For the purpose of simplification of the disclosure, the detailed construction of intake-side cylinder cutoff mechanism 5 is hereunder described.

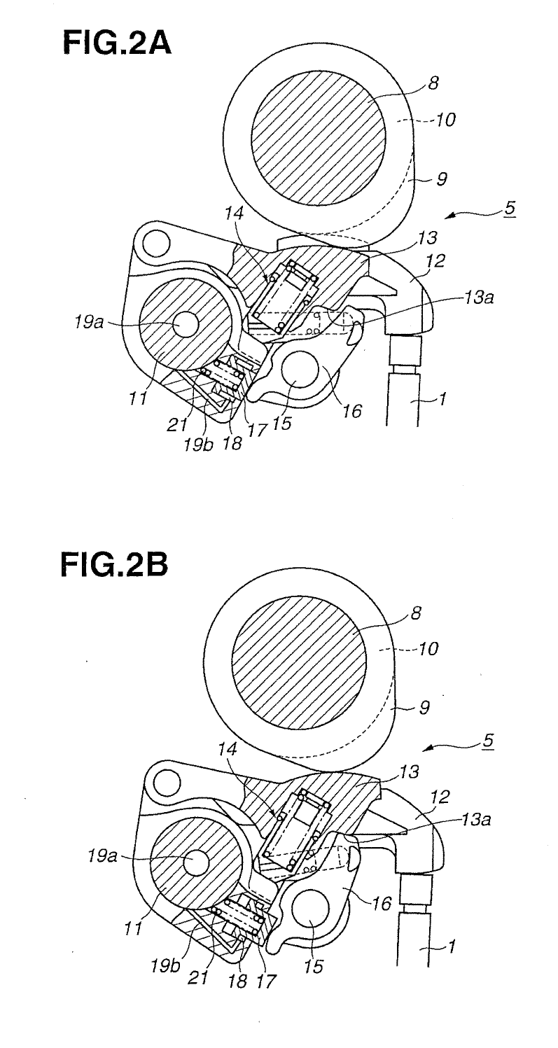

The previously-discussed intake-side cylinder cutoff mechanism 5 is constructed by a so-called variable valve lift (VVL) mechanism. As shown in FIGS. 1 and 2A-2B, intake-side cylinder cutoff mechanism 5 is comprised of a substantially oval middle-lift cam 9, a pair of cylindrical zero-lift cams 10, 10, a main rocker arm 12, a sub-rocker arm 13, a lost-motion mechanism 14, a spring-loaded lever member 16 and its return spring, and a hydraulic plunger 17 and its coil spring 21. Middle-lift cam 9 is integrally formed on the outer periphery of an intake camshaft 8 and located above the cylinder head of the #1-cylinder. Cylindrical zero-lift cams 10, 10 are located on both sides of middle-lift cam 9. Main rocker arm 12 is pivotably supported on a rocker shaft 11 and formed integral with a pair of cam-follower portions. The cam-follower portions are configured to be conformable to respective axial positions of cylindrical zero-lift cams 10, 10 and also configured such that the lower ends of the tips of the cam-follower portions are kept in abutted-engagement with the respective valve stem ends of intake valves 1, 1. Sub-rocker arm 13 is mounted on the rocker shaft 11 so as to be conformable to the axial position of middle-lift cam 9 and configured to be operated in a lost-motion mode. Lost-motion mechanism 14 is installed in the main rocker arm 12 for biasing the sub-rocker arm 13 toward the middle-lift cam 9. Lever member 16 is pivotably supported on a support shaft 15 fixedly connected to the main rocker arm 12. Lever member 16 is configured to permit (enable) movement of sub-rocker arm 13 in synchronism with a rocking motion of main rocker arm 12 by movement of the lever member 16 into engagement with a jaw-like lower end 13a of sub-rocker arm 13 and to inhibit (disable) movement of sub-rocker arm 13 in synchronism with a rocking motion of main rocker arm 12 by movement of the lever member 16 out of engagement with the jaw-like lower end 13a of sub-rocker arm 13. Hydraulic plunger 17 and its coil spring 21 installed in the plunger 17 under preload are provided for movement of the lever member 16 into and out of engagement with the lower end 13a of sub-rocker arm 13.

The previously-discussed hydraulic plunger 17 has a pressure-receiving flange on which a hydraulic pressure of working fluid, supplied from an oil pump 20 through an axial hydraulic passage 19a formed in the rocker shaft 11 and a hydraulic passage 19b formed in the main rocker arm 12 into a hydraulic chamber 18 defined on the outer periphery of hydraulic plunger 17, acts. In the presence of a hydraulic-pressure supply from oil pump 20 through hydraulic passages 19a-19b to hydraulic chamber 18, a retreating movement of hydraulic plunger 17 apart from the lower tab-like portion of lever member 16 occurs. In the absence of the hydraulic-pressure supply, an advancing movement of hydraulic plunger 17 toward the lower tab-like portion of lever member 16 occurs owing to a spring force of coil spring 21.

Also provided is an electromagnetically-operated cylinder cutoff switching valve 22 which is configured to switch between fluid-communication (a first flow-path configuration) between hydraulic passages 19a-19b and a drain passage 23 and fluid-communication (a second flow-path configuration) between hydraulic passages 19a-19b and a discharge passage 20a of oil pump 20. Responsively to a control current generated from a controller 24, switching between the first flow-path configuration and the second flow-path configuration is accomplished through the use of the cylinder cutoff switching valve 22.

As previously described, the exhaust-side cylinder cutoff mechanism 6 is similar to the intake-side cylinder cutoff mechanism 5 in construction. Hence, component parts of exhaust-side cylinder cutoff mechanism 6 are hereunder explained briefly.

As shown in FIG. 1, exhaust-side cylinder cutoff mechanism 6 is comprised of a middle-lift cam 41, a pair of cylindrical zero-lift cams 42, 42, a main rocker arm 44, a sub-rocker arm 45, a lost-motion mechanism 46, a spring-loaded lever member (not shown), and a hydraulic plunger (not shown) and its coil spring (not shown). Middle-lift cam 41 is integrally formed on the outer periphery of an exhaust camshaft 40 extending in the longitudinal direction of the engine and located above the cylinder head of the #1-cylinder. Cylindrical zero-lift cams 42, 42 are located on both sides of middle-lift cam 41. Main rocker arm 44 is pivotably supported on a rocker shaft 43 and formed integral with a pair of cam-follower portions. The cam-follower portions are configured to be conformable to respective axial positions of cylindrical zero-lift cams 42, 42 and also configured such that the lower ends of the tips of the cam-follower portions are kept in abutted-engagement with the respective valve stem ends of exhaust valves 3, 3. Sub-rocker arm 45 is mounted on the rocker shaft 43 so as to be conformable to the axial position of middle-lift cam 41 and configured to be operated in a lost-motion mode. Lost-motion mechanism 46 is installed in the main rocker arm 44 for biasing the sub-rocker arm 45 toward the middle-lift cam 41. The lever member (not shown) is pivotably supported on a support shaft (not shown) fixed to the main rocker arm 44. The lever member is configured to permit (enable) movement of sub-rocker arm 45 in synchronism with a rocking motion of main rocker arm 44 by movement of the lever member into engagement with a lower end of sub-rocker arm 45 and to inhibit (disable) movement of sub-rocker arm 45 in synchronism with a rocking motion of main rocker arm 44 by movement of the lever member out of engagement with the lower end of sub-rocker arm 45. The hydraulic plunger (not shown) and its coil spring are provided for movement of the lever member into and out of engagement with the lower end of sub-rocker arm 45. The hydraulic plunger (not shown) has a pressure-receiving flange on which a hydraulic pressure of working fluid, supplied from oil pump 20 through an axial hydraulic passage 43a formed in the rocker shaft 43 and a hydraulic passage (not shown) formed in the main rocker arm 44 into a hydraulic chamber (not shown) defined on the outer periphery of the hydraulic plunger, acts. In the presence of a hydraulic-pressure supply from oil pump 20 through the hydraulic passage 43a and the hydraulic passage formed in the main rocker arm 44 to the hydraulic chamber, a retreating movement of the hydraulic plunger apart from the tab-like portion of the lever member occurs. In the absence of the hydraulic-pressure supply, an advancing movement of the hydraulic plunger toward the tab-like portion of the lever member occurs owing to a spring force of the coil spring.

Responsively to a control current generated from the controller 24, switching between a flow-path configuration that fluid-communication between the hydraulic passage 43a and the drain passage 23 is established and fluid-communication between the hydraulic passage 43a and the discharge passage 20a is blocked and a flow-path configuration that fluid-communication between the hydraulic passage 43a and the drain passage 23 is blocked and fluid-communication between the hydraulic passage 43a and the discharge passage 20a is established is accomplished through the use of the cylinder cutoff switching valve 22 common to both the intake-side cylinder cutoff mechanism 5 and the exhaust-side cylinder cutoff mechanism 6.

As shown in FIG. 1, the previously-discussed controller 24 (an electronic control unit (ECU) or an electronic control module) generally comprises a microcomputer.

Controller 24 includes an input/output interface (I/O), memories (RAM, ROM), and a microprocessor or a central processing unit (CPU). The input/output interface (I/O) of controller 24 receives input information from various engine/vehicle sensors, namely a crank angle sensor (a crankshaft position sensor), an airflow meter, an engine temperature sensor (an engine coolant temperature sensor), an oil temperature sensor, and a throttle-opening sensor (a throttle position sensor), and the like. The throttle-opening sensor is provided for detecting a throttle-opening degree of a throttle valve 50. Within the controller 24, the central processing unit (CPU) allows the access by the I/O interface of input informational data signals from the previously-discussed engine/vehicle sensors, for detecting or determining, based on latest up-to-date informational data, a current engine operating condition. Controller 24 is configured to generate a control current (a selected one of a high current value and a low current value (ON and OFF)) to the cylinder cutoff switching valve 22 and to generate a control current (a selected one of a high current value and a low current value) to a variable lift switching valve 36 (described later), depending on the detected engine operating condition.

### [Operations of Intake-Side Cylinder Cutoff Mechanism 5 and Exhaust-Side Cylinder Cutoff Mechanism 6]

Operations of intake-side cylinder cutoff mechanism 5 and exhaust-side cylinder cutoff mechanism 6 are hereunder explained, but the operations (actions) are almost the same in these cylinder cutoff mechanisms 5-6. Hence, the operation of intake-side cylinder cutoff mechanism 5 is mainly explained hereunder in reference to FIGS. 2A-2B.

First, when a current flow from the controller 24 to the cylinder cutoff switching valve 22 is cut off or stopped, that is, when the cylinder cutoff switching valve 22 is de-energized, fluid-communication between hydraulic passages 19a-19b and drain passage 23 becomes established. Hence, a drop of hydraulic pressure in the hydraulic chamber 18 occurs. Therefore, as shown in FIG. 2B, an advancing movement of hydraulic plunger 17 occurs owing to a spring force of coil spring 21, and thus the lever member 16 rotates anticlockwise against the return-spring force. As a result, during cam-connection between the base circle of the intake-side middle-lift cam 9 and the tip of lever member 16, the top end of the lever member 16 is brought into engagement with the jaw-like lower end 13a of sub-rocker arm 13 so as to permit movement of sub-rocker arm 13 in synchronism with a rocking motion of main rocker arm 12. In a similar manner, regarding the exhaust-valve side, during cam-connection between the base circle of the exhaust-side middle-lift cam 41 and the tip of the lever member, the top end of lever member is brought into engagement with the jaw-like lower end of sub-rocker arm 45 so as to permit movement of sub-rocker arm 45 in synchronism with a rocking motion of main rocker arm 44.

Accordingly, a rocking motion of the intake-side main rocker arm 12 by means of a cam profile of the intake-side middle-lift cam 9 is produced, and thus a valve lift characteristic of each of intake valves 1, 1 is switched or controlled to a middle valve lift amount. In a similar manner, regarding the exhaust-valve side, a rocking motion of the exhaust-side main rocker arm 44 by means of a cam profile of the exhaust-side middle-lift cam 41 is produced, and thus a valve lift characteristic of each of exhaust valves 3, 3 is switched or controlled to a middle valve lift amount. Concretely, the valve lift amount of each of intake valves 1, 1 becomes a given middle valve lift L_{I}3, whereas the valve lift amount of each of exhaust valves 3, 3 becomes a given middle valve lift L_{E}1.

For instance, when the engine has stopped running, that is, when there is no action of hydraulic pressure (no switching energy for mode-switching/conversion) from oil pump 20 to plunger 17, in other words, at a default mode, as discussed previously, each of intake valves 1, 1 on the #1-cylinder side is so operated as to produce the previously-discussed middle valve lift L_{I}3, while each of exhaust valves 3, 3 on the #1-cylinder side is so operated as to produce the previously-discussed middle valve lift L_{E}1.

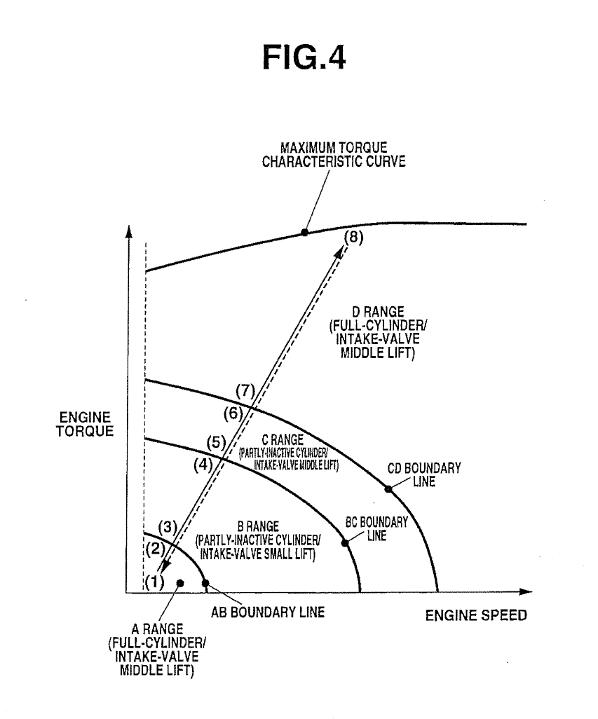

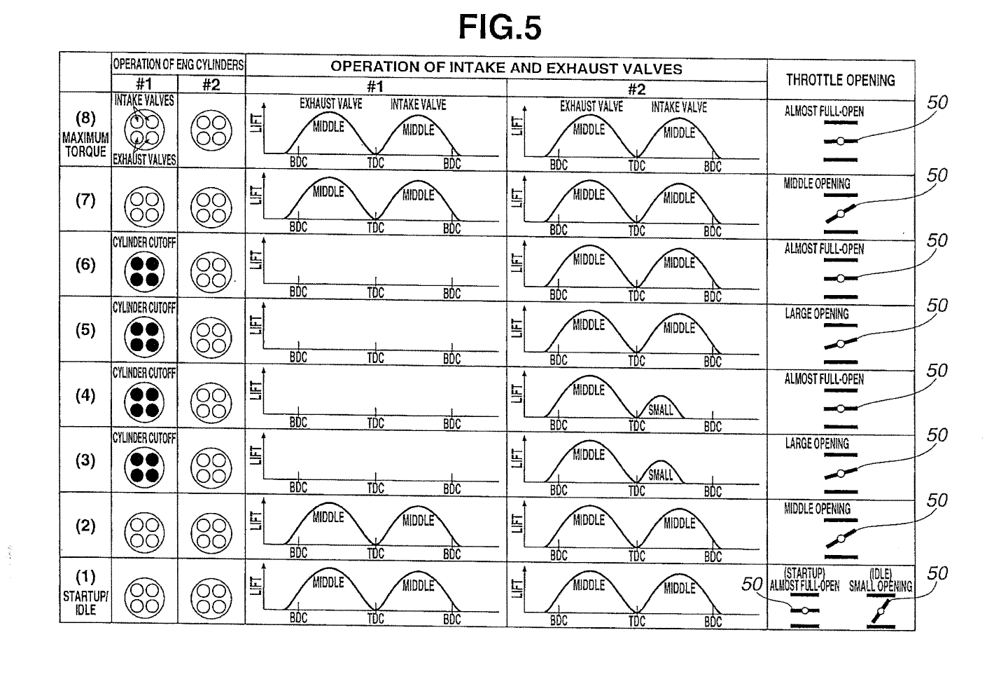

The engine operating range, wherein a current flow from the controller 24 to the cylinder cutoff switching valve 22 is cut off or stopped, is equivalent to an “A” range shown in the VVA system control map of FIG. 4 (i.e., the (1)-(2) operating range shown in the characteristic diagram of FIG. 5), corresponding to a low-speed low-load range containing an engine startup period and/or an idling period, and a “D” range shown in the VVA system control map of FIG. 4 (i.e., the (7)-(8) operating range shown in the characteristic diagram of FIG. 5), corresponding to a high-speed high-load range.

Conversely when a current flow from the controller 24 to the cylinder cutoff switching valve 22 is produced, that is, when the cylinder cutoff switching valve 22 is energized, fluid-communication between hydraulic passages 19a-19b and drain passage 23 becomes blocked. Hence, a hydraulic pressure of working fluid, discharged from the oil pump 20, is supplied through hydraulic passages 19a-19b to the hydraulic chamber 18. Therefore, as shown in FIG. 2A, a retreating movement of hydraulic plunger 17 against the spring force of coil spring 21 occurs, and thus the lever member 16 rotates clockwise by the return-spring force. As a result, the top end of the lever member 16 is brought out of engagement with the jaw-like lower end 13a of sub-rocker arm 13 so as to inhibit movement of sub-rocker arm 13 in synchronism with a rocking motion of main rocker arm 12. Accordingly, sub-rocker arm 13 becomes held in a lost-motion state by means of the lost-motion mechanism 14. For this reason, main rocker arm 12 is merely kept in sliding-contact with the cylindrical zero-lift cams 10, 10 without receiving a valve-lift push back force from the intake-side middle-lift cam 9. Hence, the valve lift amount of each of intake valves 1, 1 becomes a zero valve lift. In this manner, a stopped (inactive) state of intake valves 1, 1 becomes created by means of the intake-side cylinder cutoff mechanism 5. In a similar manner, regarding the exhaust-valve side, a stopped (inactive) state of exhaust valves 3, 3 becomes created by means of the exhaust-side cylinder cutoff mechanism 6. As a result of this, the #1-cylinder is brought into a cylinder cutoff mode (or an inactive cylinder mode).

The engine operating range, wherein a current flow from the controller 24 to the cylinder cutoff switching valve 22 is produced, is equivalent to engine operating conditions from a “B” range shown in the VVA system control map of FIG. 4 (i.e., the (3)-(4) operating range shown in the characteristic diagram of FIG. 5), corresponding to a comparatively (somewhat) low-speed low-load range, to a “C” range shown in the VVA system control map of FIG. 4 (i.e., the (5)-(6) operating range shown in the characteristic diagram of FIG. 5), corresponding to a middle-speed middle-load range.

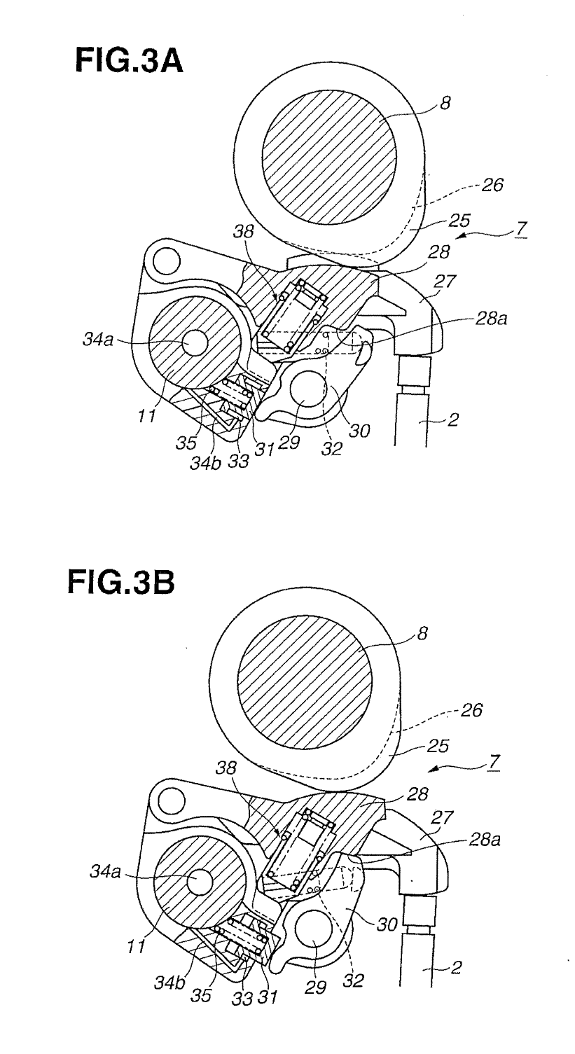

As seen from the partial cross sections of FIGS. 3A-3B, the fundamental construction of the previously-discussed intake-side variable valve lift (VVL) mechanism 7 of the #2-cylinder is similar to each of intake-side cylinder cutoff mechanism 5 and exhaust-side cylinder cutoff mechanism 6.

That is, intake-side variable valve lift (VVL) mechanism 7 is comprised of a middle-lift cam 25, a pair of small-lift cams 26, 26, a main rocker arm 27, a sub-rocker arm 28, a lost-motion mechanism 38, a spring-loaded lever member 30 and its return spring 32, and a hydraulic plunger 31 and its coil spring 35. Middle-lift cam 25 is integrally formed on the outer periphery of intake camshaft 8 and located above the cylinder head of the #2-cylinder. Small-lift cams 26, 26 are located on both sides of middle-lift cam 25. A cam profile of each of small-lift cams 26, 26 is configured to produce a smaller cam lift amount as compared to a cam lift amount of middle-lift cam 25. Main rocker arm 27 is pivotably supported on the rocker shaft 11 and formed integral with a pair of cam-follower portions. The cam-follower portions are configured to be conformable to respective axial positions of small-lift cams 26, 26 and also configured such that the lower ends of the tips of the cam-follower portions are kept in abutted-engagement with the respective valve stem ends of intake valves 2, 2. Sub-rocker arm 28 is mounted on the rocker shaft 11 so as to be conformable to the axial position of middle-lift cam 25 and configured to be operated in a lost-motion mode. Lost-motion mechanism 38 is installed in the main rocker arm 27 for biasing the sub-rocker arm 28 toward the middle-lift cam 25. Lever member 30 is pivotably supported on a support shaft 29 fixedly connected to the main rocker arm 27. Lever member 30 is configured to permit (enable) movement of sub-rocker arm 28 in synchronism with a rocking motion of main rocker arm 27 by movement of the lever member 30 into engagement with a jaw-like lower end 28a of sub-rocker arm 28 and to inhibit (disable) movement of sub-rocker arm 28 in synchronism with a rocking motion of main rocker arm 27 by movement of the lever member 30 out of engagement with the jaw-like lower end 28a of sub-rocker arm 28. Hydraulic plunger 31 and its coil spring 35 installed in the plunger 31 under preload are provided for movement of the lever member 30 into and out of engagement with the lower end 28a of sub-rocker arm 28.

The previously-discussed hydraulic plunger 31 has a pressure-receiving flange on which a hydraulic pressure of working fluid, supplied from oil pump 20 through an axial hydraulic passage 34a formed in the rocker shaft 11 and a hydraulic passage 34b formed in the main rocker arm 27 into a hydraulic chamber 33 defined on the outer periphery of hydraulic plunger 31, acts. In the presence of a hydraulic-pressure supply from oil pump 20 through hydraulic passages 34a-34b to hydraulic chamber 33, a retreating movement of hydraulic plunger 31 apart from the lower tab-like portion of lever member 30 occurs. In the absence of the hydraulic-pressure supply, an advancing movement of hydraulic plunger 31 toward the lower tab-like portion of lever member 30 occurs owing to a spring force of coil spring 35.

Also provided is an electromagnetically-operated variable lift switching valve 36 which is configured to switch between fluid-communication (a first flow-path configuration) between hydraulic passages 34a-34b and a drain passage 23 and fluid-communication (a second flow-path configuration) between hydraulic passages 34a-34b and the discharge passage 20a of oil pump 20. Responsively to a control current generated from controller 24, switching between the first flow-path configuration and the second flow-path configuration is accomplished through the use of the variable lift switching valve 36.

### [Operation of Intake-Side Variable Valve Lift (VVL) Mechanism 7]

By means of the intake-side VVL mechanism 7 having the construction as previously discussed, each of intake valves 2, 2 on the #2-cylinder side is always operated (working or active). When a current flow from the controller 24 to the variable lift switching valve 36 is cut off or stopped, that is, when the variable lift switching valve 36 is de-energized, fluid-communication between hydraulic passages 34a-34b and drain passage 37 becomes established. Hence, a drop of hydraulic pressure in the hydraulic chamber 33 occurs. Thus, the intake-side VVL mechanism 7 is operated in a default mode that there is no action of hydraulic pressure (no switching energy for mode-switching/conversion) from oil pump 20 to plunger 31. Therefore, as shown in FIG. 3B, an advancing movement of hydraulic plunger 31 occurs owing to a spring force of coil spring 35, and thus the lever member 30 rotates anticlockwise against the return-spring force. As a result, the top end of the lever member 30 is brought into engagement with the jaw-like lower end 28a of sub-rocker arm 28 so as to permit movement of sub-rocker arm 28 in synchronism with a rocking motion of main rocker arm 27 through the lever member 30. Accordingly, each of intake valves. 2, 2 is operated (opened or closed) in a middle valve lift characteristic mode by means of the middle-lift cam 25.

Conversely when a current flow from the controller 24 to the variable lift switching valve 36 is produced, that is, when the variable lift switching valve 36 is energized, fluid-communication between hydraulic passages 34a-34b and drain passage 37 becomes blocked and fluid-communication between hydraulic passages 34a-34b and discharge passage 20a of oil pump 20 becomes established. Hence, a hydraulic pressure of working fluid, discharged from the oil pump 20, is supplied through hydraulic passages 34a-34b to the hydraulic chamber 33. Therefore, as shown in FIG. 3A, a retreating movement of hydraulic plunger 31 against the spring force of coil spring 35 occurs, and thus the lever member 30 rotates clockwise about the support shaft 29 by the spring force of return spring 32. As a result, the top end of the lever member 30 is brought out of engagement with the jaw-like lower end 28a of sub-rocker arm 28 so as to inhibit movement of sub-rocker arm 28 in synchronism with a rocking motion of main rocker arm 27. Accordingly, each of intake valves 2, 2 is operated (opened or closed) in a small valve lift characteristic mode by means of the small-lift cams 26, 26.

As previously-discussed, each of exhaust valves 4, 4 on the #2-cylinder side is operated in a fixed (constant) valve lift characteristic mode. The substantially oval middle-lift cam 49, which has the same cam profile as the #1-cylinder middle-lift cam 41, is integrally formed on the outer periphery of exhaust camshaft 40. The substantially rectangular swing arm 47 is pivotably mounted on the rocker shaft 43. Swing arm 47 has a pair of protruding portions 47a, 47a, which are kept in abutted-engagement with the respective valve stem ends of exhaust valves 4, 4. Also, swing arm 47 has a fixed cam-follower portion 48 integrally formed at a substantially center of the upper face. The previously-discussed middle-lift cam 49 is kept in sliding-contact with the fixed cam-follower portion 48. Accordingly, each of the #2-cylinder exhaust valves 4, 4 is always operated (opened or closed) by means of the middle-lift cam 49 at a middle valve-lift characteristic of the same middle valve lift amount L_{E}1 as the #1-cylinder middle-lift cam 41.

Referring to FIG. 4, there is shown the VVA system control map showing how the number of working (active) engine cylinders and valve lift characteristics have to be varied with respect to a change in engine operating condition. In the map of FIG. 4, the axis of abscissa (i.e., the x-axis) represents engine speed, whereas the axis of ordinate (i.e., the y-axis) represents engine torque.

As appreciated from the map of FIG. 4, the “A” range of the lower-speed and lower-torque side containing an engine startup period and an engine idle as well as the “D” range of the higher-speed and higher-torque side is a so-called full-cylinder operating range.

In the “A” and “D” ranges, regarding both the #1-cylinder and the #2-cylinder, intake valves 1, 1 and exhaust valves 3, 3, included in the #1-cylinder, and intake valves 2, 2 and exhaust valves 4, 4, included in the #2-cylinder, are all operated in the previously-discussed middle valve lift characteristic mode. That is, each of the #1-cylinder intake valves 1, 1 is operated (opened or closed) at a middle valve-lift characteristic of the given middle valve lift amount L_{I}3 with the intake-side cylinder cutoff mechanism 5 operating in an active (working) valve mode. On the other hand, each of the #2-cylinder intake valves 2, 2 is operated (opened or closed) at a middle valve-lift characteristic of a given middle valve lift amount L_{I}2 with the intake-side variable valve lift (VVL) mechanism 7 operating in a middle valve lift characteristic mode. In the shown embodiment, the given middle valve lift amount L_{I}2 is set to be equal to the given middle valve lift amount L_{I}3, that is, L_{I}2=L_{I}3. Hence, intake valves 1, 1, 2, 2 of all engine cylinders (i.e., both of the #1-cylinder and the #2-cylinder in the shown embodiment) are operated (opened or closed) at the same middle valve lift amount L_{I}2=L_{I}3. Furthermore, regarding the exhaust-valve side, each of the #1-cylinder exhaust valves 3, 3 is operated at a middle valve-lift characteristic of the given middle valve lift amount L_{E}1 with the exhaust-side cylinder cutoff mechanism 6 operating in an active (working) valve mode. On the other hand, each of the #2-cylinder exhaust valves 4, 4 is operated (opened or closed) at a middle valve-lift characteristic of the same middle valve lift amount L_{E}1 as the #1-cylinder middle-lift cam 41, associated with the #1-cylinder exhaust valves 3, 3, by means of the fixed valve-lift-characteristic swing arm 47. Hence, exhaust valves 3, 3, 4, 4 of all engine cylinders (i.e., both of the #1-cylinder and the #2-cylinder in the shown embodiment) are operated (opened or closed) at the same middle valve lift amount L_{E}1.

As discussed previously, in the “A” and “D” ranges, the multi-cylinder internal combustion engine is operated in a full-cylinder operating mode at which intake and exhaust valves 1, 1, 2, 2, 3, 3, 4, 4 are all operated in their middle valve lift characteristic modes (i.e., L_{I}3, L_{I}2, L_{E}1, L_{E}1). In the VVA apparatus of the first embodiment, this VVA system control mode corresponds to the aforementioned default mode. That is, in the default mode that no action of hydraulic pressure (no switching energy for mode-switching/conversion) from oil pump 20 to each of the cylinder cutoff switching valve 22 and the intake-side variable lift switching valve 36, the VVA system is placed into a mechanically stable operating mode (in other words, a mechanical fail-safe operating mode).

In contrast, in the “B” and “C” ranges midway between the “A” range and the “D” range, the multi-cylinder internal combustion engine is operated in a partly-inactive cylinder operating mode at which the #1-cylinder is kept in an inactive cylinder mode and only the #2-cylinder is active or working (combusting).

In the “B” range, in which there is a hydraulic-pressure supply through the variable lift switching valve 36 to the intake-side variable valve lift (VVL) mechanism 7, each of the #2-cylinder intake valves 2, 2, which are always working, is operated (opened or closed) at a small valve-lift characteristic of a given small valve lift L_{I}1. In contrast, in the “C” range, in which there is no hydraulic-pressure supply through the variable lift switching valve 36 to the intake-side variable valve lift (VVL) mechanism 7, each of the #2-cylinder intake valves 2, 2 is operated (opened or closed) at a middle valve-lift characteristic of the given middle valve lift L_{I}2.

By the way, in the “B” and “C” ranges, in which there is a hydraulic-pressure supply through the cylinder cutoff switching valve 22 to each of intake-side cylinder cutoff mechanism 5 and exhaust-side cylinder cutoff mechanism 6, the #1-cylinder intake valves 1, 1 and the #1-cylinder exhaust valves 3, 3 are all kept inactive and hence only the #1-cylinder is shifted to an inactive cylinder mode.

That is to say, continuously from the “B” range in the “C” range the cylinder cutoff switching valve 22 is held in the working-fluid supply mode (the hydraulic-pressure supply mode) that there is a hydraulic-pressure supply through the cylinder cutoff switching valve 22 to each of intake-side cylinder cutoff mechanism 5 and exhaust-side cylinder cutoff mechanism 6. Therefore, the #1-cylinder is continuously kept in the inactive cylinder mode. On the other hand, the variable lift switching valve 36 is switched to the working-fluid drain mode that there is no hydraulic-pressure supply through the variable lift switching valve 36 to the intake-side variable valve lift (VVL) mechanism 7. Hence, each of the #2-cylinder intake valves 2, 2 is shifted to a middle valve-lift characteristic mode of the given middle valve lift L_{I}2 (a relatively greater lift amount).

On the control map of FIG. 4, the engine operating condition (1) denotes an engine startup period or an idling period. Suppose that an accelerator-pedal depression starts to develop from the initial operating condition (1), and then the engine/vehicle is accelerated with a gradual change in operating conditions (1)→(2)→(3)→(4)→(5)→(6)→(7)→(8).

First, during the engine startup period, as appreciated from the operating condition (1) shown in the control map of FIG. 4 and also shown in the characteristic diagram of FIG. 5, the engine is operated in a full-cylinder operating mode. That is, the #1-cylinder and the #2-cylinder are both active (working), and thus intake and exhaust valves 1, 1, 2, 2, 3, 3, 4, 4 of the #1-cylinder and the #2-cylinder are all operated (opened or closed) in their middle valve lift characteristic modes (i.e., L_{I}3, L_{I}2, L_{E}1, L_{E}1).

When the engine is started up and combustion starts to develop, all engine cylinders are working (combusting) and thus a rapid engine speed-rise occurs. With the #1-cylinder intake valves 1, 1 and the #2-cylinder intake valves 2, 2 operated in the respective middle valve lift characteristic modes (i.e., the #1-cylinder middle valve lift L_{I}3 and the #2-cylinder middle valve lift L_{I}2), intake valve closure timing (IVC) of each of intake valves 1, 1, 2, 2 is controlled to a slightly phase-retarded timing value after a piston bottom dead center (ABDC). Also, at this slightly phase-retarded timing after BDC, the opening of throttle valve 50 becomes an almost full-open state. As a synergistic effect of the intake valve closure timing (IVC) controlled to the slightly phase-retarded timing value after EDC and the almost full-open throttle, a charging efficiency of intake air entering the engine cylinder becomes sufficiently high, and therefore a torque per cylinder can be enhanced. This contributes to the greatly-enhanced startability.

In particular, when the engine is started from cold, the engine has the difficulty in smoothly rising engine revolution speed owing to a comparatively large internal friction. However, in the first embodiment, during cold-start operation, the engine is operated in a full-cylinder operating mode and the #1-cylinder intake valves 1, 1 and the #2-cylinder intake valves 2, 2 are operated in the respective middle valve lift characteristic modes. Hence, a charging efficiency of intake air can be sufficiently enhanced and thus combustion torque can be sufficiently enhanced. Additionally, all engine cylinders produce combustion torque. Thus, it is possible to more greatly improve the startability.

Even when warm-up (fast idle) of the engine has been completed after starting and thus the engine operating condition shifts into a usual idle operating mode, as appreciated from the operating condition (1) shown in the control map of FIG. 4 and also shown in the characteristic diagram of FIG. 5, on one hand, the full-cylinder operating mode and the middle valve lift characteristic modes of the #1-cylinder intake valves 1, 1 and the #2-cylinder intake valves 2, 2 are continuously executed. On the other hand, when the engine is idling hot, the internal friction of the engine lowers. As seen from the opening of throttle valve 50 under the operating condition (1) shown in the control map of FIG. 4, the throttle opening used during the idling period is throttled or reduced to a small opening degree, as compared to the throttle opening used during the engine startup period.

With the #1-cylinder intake valves 1, 1 and the #2-cylinder intake valves 2, 2 operated in the respective middle valve lift characteristic modes, intake valve closure timing (IVC) of each of intake valves 1, 1, 2, 2 is controlled to a slightly phase-retarded timing after EDC. Hence, owing to a high effective compression ratio the combustion at light engine loads is improved. Additionally, owing to a less valve overlap during which the intake and exhaust valves 1, 3 of the #1-cylinder are both open and a less valve overlap during which the intake and exhaust valves 2, 4 of the #2-cylinder are both open, there is a less in-cylinder residual gas (i.e., a less internal exhaust gas recirculation (internal EGR)), thereby more greatly improving the combustion.

Under these conditions, suppose that the engine is placed from the full-cylinder operating mode into a partly-inactive cylinder operating mode. In such a case, an explosion-to-explosion interval doubles and thus revolution speed fluctuations of the engine tends to increase. This undesirably produces unnatural feeling that the driver experiences uncomfortable idling vibrations and idling speed fluctuations even in an idling operating range (i.e., during vehicle standstill), in which the engine has to be usually running quietly. For the reasons discussed above, at idling operation, mode-switching to a partly-inactive cylinder operating mode is disabled (inhibited).

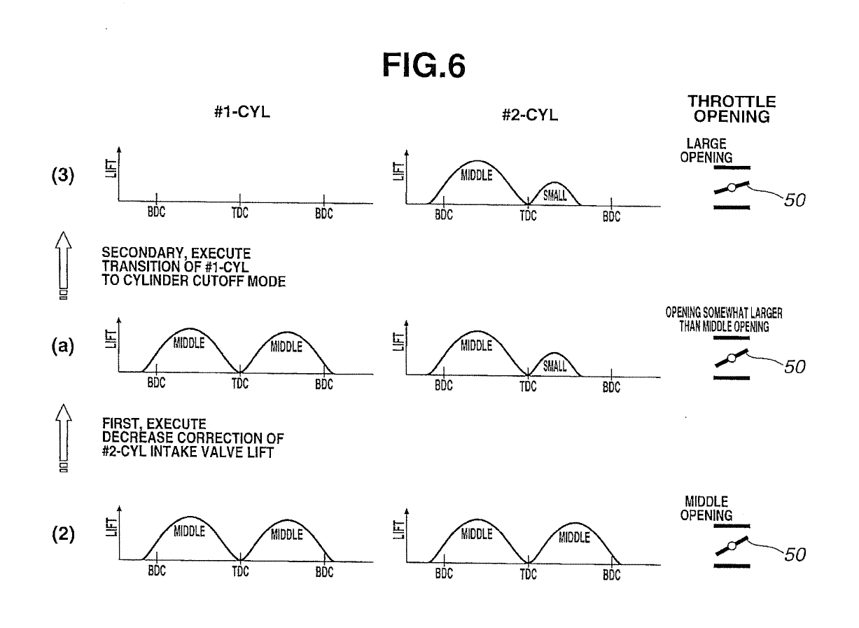

Thereafter, when the accelerator pedal is depressed from the idling condition, engine speed and engine torque both begin to increase. Hence, as appreciated from the operating condition (2) shown in the control map of FIG. 4 and also shown in the characteristic diagram of FIG. 5, the opening of throttle valve 50 is increased in concert with a driver's vehicle-acceleration requirement (an engine output increase requirement). After this, immediately when exceeding the “AB” boundary line of the “A” range and the “B” range, as appreciated from the operating condition (3) shown in the characteristic diagram of FIG. 5 and the operating-mode-switching sequence chart of FIG. 6, the lift characteristic of each of the #2-cylinder intake valves 2, 2 is, first of all, converted to a given small valve lift L_{I}1. Immediately after having been converted into a small valve-lift characteristic of the given small valve lift L_{I}1, the lift characteristic of each of the #1-cylinder intake valves 1, 1 and the #1-cylinder exhaust valves 3, 3 becomes converted into a zero valve lift, so as to enable (permit) a transition of the #1-cylinder to a partly-inactive cylinder operating mode (a cylinder cutoff mode).

The level of noise/vibrations produced on the engine or vehicle, generally, tends to increase owing to an increase in engine speed and/or engine torque, and thus the driver becomes insensitive to revolution speed fluctuations of the engine and/or rotational vibrations of the engine. For this reason, the previously-discussed transition of the #1-cylinder to a partly-inactive cylinder operating mode (a cylinder cutoff mode), in which fuel economy can be improved, occurs.

Hereupon, there are the following three principles of improving fuel economy by virtue of the partly-inactive cylinder operating mode.

The first principle is that, for the same engine torque, during the partly-inactive cylinder operating mode the number of working (active) engine cylinders becomes reduced to half. Thus, the surface area in the cylinder, with which an air-fuel mixture and/or combustion gas can be brought into contact, also becomes reduced to half. As a result of this, a cooling loss is reduced and hence a thermal efficiency is enhanced, thereby improving fuel economy.

The second principle is that during the partly-inactive cylinder operating mode the number of working (active) engine cylinders becomes reduced to half, and thus the opening of throttle valve 50 becomes increased relatively for the same engine torque. This results in a decrease in intake manifold pressure (a vacuum or a negative pressure), thereby reducing a pumping loss.

The third principle is that during the partly-inactive cylinder operating mode the number of working (active) engine valves of the valve operating system becomes reduced to half and hence the overall friction of the valve operating system becomes greatly reduced.

By means of the previously-discussed three principles (three mechanisms), during the partly-inactive cylinder operating mode it is possible to improve fuel economy, in other words, it is possible to reduce a fuel consumption rate.

Returning to the operating condition (3) (that is, “B” range) of the control map of FIG. 4 and the characteristic diagram of FIG. 5, the aim of switching (converting) the lift characteristic of each of the #2-cylinder intake valves 2, 2, which is always operated (working or active), from a middle valve-lift characteristic of the given middle valve lift L_{I}2 to a small valve-lift characteristic of the given small valve lift L_{I}1 in addition to the transition to the partly-inactive cylinder operating mode, is to more greatly improve a fuel-consumption reducing effect during the partly-inactive cylinder operating mode.

That is to say, first, suppose that the lift characteristic of each of the #2-cylinder intake valves 2, 2 remains unchanged (i.e., kept at the middle valve-lift characteristic). In such a case, a charging efficiency of intake air entering the engine cylinder is kept high, and hence the opening of throttle valve 50 has to be throttled or reduced to a certain extent even during the partly-inactive cylinder operating mode. This leads to a comparatively large pumping loss. To avoid this, switching from the middle-lift cam 25 having a high charging efficiency to the small-lift cams 26, 26 having a small charging efficiency occurs and thus intake valve closure timing (IVC) of each of the #2-cylinder intake valves 2, 2 is controlled to a phase-advanced timing value before a piston bottom dead center (BBDO), thereby relatively increasing the opening of throttle valve 50 for the same engine torque. Accordingly, it is possible to sufficiently reduce a pumping loss.

Secondly, in the case of the lift characteristic of each of the #2-cylinder intake valves 2, 2 remaining unchanged (i.e., kept at the middle valve-lift characteristic), the overall friction of the valve operating system is not yet reduced sufficiently even during the partly-inactive cylinder operating mode. For this reason, switching to a small valve-lift characteristic of the given small valve lift L_{I}1 occurs, thereby more greatly reducing the overall friction of the valve operating system.

By virtue of the previously-discussed two technical effects combined with each other, that is, by switching (conversion) of the lift characteristic of each of the #2-cylinder intake valves 2, 2, which is always operated (working or active), from a middle valve-lift characteristic of the given middle valve lift L_{I}2 to a small valve-lift characteristic of the given small valve lift L_{I}1 in addition to the transition to the partly-inactive cylinder operating mode, it is possible to more greatly improve a fuel-consumption reducing effect during the partly-inactive cylinder operating mode.

Subsequently to the above, when the accelerator pedal is further depressed from the operating condition (3) of the control map of FIG. 4 and the characteristic diagram of FIG. 5, engine speed and engine torque further increase. During changing operating conditions from the operating condition (3) to the operating condition (4) in the characteristic diagram of FIG. 5, the opening of throttle valve 50 is increased from the large throttle opening to an almost full-throttle.

However, as discussed previously, the pumping loss is reduced, but each of the #2-cylinder intake valves 2, 2 is operated at a small valve-lift characteristic of the given small valve lift L_{I}1 at which it is hard to increase the charging efficiency, in other words, intake valve closure timing (IVC) of each of the #2-cylinder intake valves 2, 2 is controlled to a phase-advanced timing before BDC (so-called early intake valve closure timing). Even with the throttle valve 50 controlled to the almost full-open throttle, in other words, even under the operating condition (4) near the “BC” boundary line of the “B” range and “C” range, due to the so-called early IVC the engine torque tends to reach its top (the uppermost limit).

Therefore, on the operating condition (5) of the control map of FIG. 4, the lift characteristic of each of the #2-cylinder intake valves 2, 2, which is always operated (working or active), is switched again from the small valve-lift characteristic of the given small valve lift L_{I}1 to the middle valve-lift characteristic of the given middle valve lift L_{I}2. Concretely, the variable lift switching valve 36 is switched again to the working-fluid drain mode that there is no hydraulic-pressure supply through the variable lift switching valve 36 to the intake-side variable valve lift (VVL) mechanism 7, so as to enable a transition to the “B” range to the “C” range.

As discussed previously, this middle valve-lift characteristic (of the given middle valve lift L_{I}2) of each of the #2-cylinder intake valves 2, 2, is set such that intake valve closure timing (IVC) of each of #2-cylinder intake valves 2, 2 is controlled to a slightly phase-retarded timing value after BDC and thus the charging efficiency becomes high. Also, on the operating condition (5), the opening of throttle valve 50 becomes controlled to a large opening throttled or narrowed slightly from the almost full-open throttle. Hence, with the throttle valve 50 controlled to the large opening, a margin for throttle opening with respect to a full-open throttle can be still allowed. Therefore, engine output torque can be further increased by further increasing the opening of throttle valve 50.

As a result of this, it is possible to enlarge the partly-inactive cylinder operating range, in which fuel economy can be improved, toward the high engine-torque side and/or the high engine-speed side. As appreciated from the control map of FIG. 4, the partly-inactive cylinder operating range can be enlarged to the operating condition (6). Conversely, suppose that the lift characteristic of each of the #2-cylinder intake valves 2, 2, which is always operated (working or active), remains kept at the small valve-lift characteristic of the given small valve lift L_{I}1, on the operating condition (5) of the control map of FIG. 4. In such a case, the partly-inactive cylinder operating range is limited to the operating condition (4).

By virtue of the partly-inactive cylinder operating range effectively enlarged to the high engine-torque side and/or the high engine-speed side as discussed above, it is possible to increase the frequency of the partly-inactive cylinder operating mode, in which fuel economy can be improved, in a practical operating range. Hence, it is possible to remarkably improve a substantial fuel-consumption reducing effect in the practical operating range.

Thereafter, in the presence of a further engine output torque increase requirement, the further engine output requirement cannot be satisfied by the partly-inactive cylinder operating mode. Thus, as appreciated from the operating condition (7) (that is, “D” range) of the control map of FIG. 4 and the characteristic diagram of FIG. 5, mode-switching to a full-cylinder operating mode occurs from the almost full-open throttle condition of throttle valve 50. Concretely, the cylinder cutoff switching valve 22 is switched again to the working-fluid drain mode that there is no hydraulic-pressure supply through the cylinder cutoff switching valve 22 to each of intake-side cylinder cutoff mechanism 5 and exhaust-side cylinder cutoff mechanism 6, so as to enable a transition to the “C” range to the “D” range.

By switching again to the full-cylinder operating mode, the number of working (combusting) engine cylinders doubles. A rapid increase in engine torque occurs, and hence the opening of throttle valve 50 is rapidly narrowed down, so as to suppress a torque shock (an engine-torque discontinuity or an abrupt change in engine torque).

When the accelerator pedal is still further depressed, engine torque and engine speed further increase owing to a gradual increase in the opening of throttle valve 50 in concert with a still further engine output increase requirement. As a result, the engine operating condition reaches the operating condition (8) on a maximum torque curve. Thereafter, when the accelerator pedal is further depressed continuously, the engine operating point moves along the maximum torque curve and shifts toward the high engine-speed side.

Conversely when the accelerator pedal is released, the operating condition returns back to the initial operating condition (1) on the map of FIG. 4 with a gradual change in operating conditions (8)→(7)→*(6)→(5)→(4)→(3)→(2)→(1) (idle).

The main effects, obtained by the shown embodiment, are summarized as follows.

In a low engine-torque range (i.e., the “B” range) during the partly-inactive cylinder operating mode, each of the #2-cylinder intake valves 2, 2 is operated at a small valve-lift characteristic of a given small valve lift L_{I}1. Hence, owing to a reduced pumping loss and a reduced friction, it is possible to more greatly improve fuel economy in the “B” range. In contrast, in a high engine-torque range (i.e., the “C” range) during the partly-inactive cylinder operating mode, the lift characteristic of each of the #2-cylinder intake valves 2, 2 is switched again to the middle valve-lift characteristic of the given middle valve lift L_{I}2 at which the charging efficiency can be enhanced. Accordingly, the partly-inactive cylinder operating range can be effectively enlarged to the high engine-torque side, and therefore it is possible to increase the frequency of the partly-inactive cylinder operating mode, in which fuel economy can be improved.

Hence, it is possible to improve a fuel-consumption reducing effect in a practical operating range. Additionally, any of intake-side cylinder cutoff mechanism 5 (serving as an intake-valve stop mechanism, in other words, an intake-valve cutoff mechanism), exhaust-side cylinder cutoff mechanism 6 (serving as an exhaust-valve stop mechanism, in other words, an exhaust-valve cutoff mechanism), and intake-side variable valve lift (VVL) mechanism 7 is configured to change a valve lift amount in a stepwise fashion (in two stages in the shown embodiment). Concretely, the intake-side cylinder cutoff mechanism 5 (the intake-valve stop mechanism) enables switching between a given middle valve lift amount L_{I}3 and a zero valve lift. The exhaust-side cylinder cutoff mechanism 6 (the exhaust-valve stop mechanism) enables switching between a given middle valve lift amount L_{E}1 and a zero valve lift. Also, the intake-side variable valve lift (VVL) mechanism 7 enables switching between a given middle valve lift amount L_{I}2 and a given small valve lift amount L_{I}1. In other words, intake-side cylinder cutoff mechanism 5 (the intake-valve stop mechanism), exhaust-side cylinder cutoff mechanism 6 (the exhaust-valve stop mechanism), and intake-side variable valve lift (VVL) mechanism 7 are similar to each other in basic construction. Also, the construction and configuration of each of these mechanisms 5, 6 and 7 are simple. Hence, the fundamental construction/configuration of the variable valve actuation (VVA) system and its control system can be simplified and unified.

Furthermore, in the shown embodiment, each of intake-side cylinder cutoff mechanism 5, exhaust-side cylinder cutoff mechanism 6, and intake-side variable valve lift (VVL) mechanism 7 is configured to change a valve lift amount in a stepwise fashion by selecting one of a plurality of different cam profiles (two different cam profiles in the shown embodiment). This contributes to a reduction in the deviation (fluctuation) between a controlled variable (the actually-controlled lift amount) and its desired value, thus ensuring a stabile engine performance.

Additionally, other effects, obtained by the VVA apparatus of the embodiment, are hereunder explained.

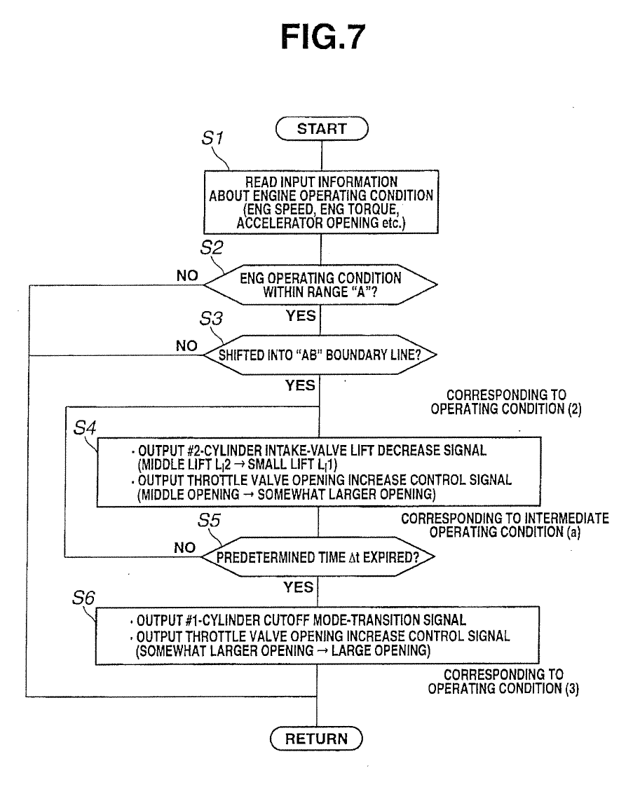

The mode-switching sequence for a transition from the operating condition (2) (i.e., “A” range, in other words, a full-cylinder/intake-valve middle-lift mode) of the control map of FIG. 4 and the characteristic diagram of FIG. 5 to the operating condition (3) (i.e., “B” range, in other words, a partly-inactive cylinder/intake-valve small-lift mode) is shown in FIG. 6. The control routine (the control flow) executed in the presence of a transition from the “A” range to the “B” range is shown in FIG. 7.

In the shown embodiment, as can be appreciated from the intermediate operating condition (a) (or the intermediate operating mode (a)) shown in FIG. 6 and provided between the operating condition (2) (i.e., “A” range) and the operating condition (3) (i.e., “B” range), during the transition from the “A” range to the “B” range, the lift characteristic of each of the #2-cylinder intake valves 2, 2 is, first of all, converted to a given small valve lift L_{I}1. Next, after having been converted into a small valve-lift characteristic of the given small valve lift L_{I}1, a transition of the #1-cylinder to a partly-inactive cylinder operating mode (a cylinder cutoff mode) occurs.

Hence, the middle-to-small intake-valve lift characteristic conversion, in which the reduction rate of a charging efficiency of intake air is small for the same throttle-valve opening, is initiated prior to the transition (mode-switching) from the full-cylinder operating mode to the partly-inactive cylinder operating mode. Immediately after a predetermined time has expired from the starting point of the middle-to-small intake-valve lift characteristic conversion, the transition (mode-switching) to the partly-inactive cylinder operating mode, in which the reduction rate of a charging efficiency of intake air is large for the same throttle-valve opening, is initiated. This contributes to a suppression (or a reduction) in torque shock.

Generally, for the purpose of suppressing an engine-torque shock, the opening of throttle opening 50 has to be rapidly increased depending on the reduction rate of a charging efficiency. However, in the VVA apparatus of the embodiment, the middle-to-small intake-valve lift characteristic conversion is initiated prior to the transition (mode-switching) to the partly-inactive cylinder operating mode. Hence, during the middle-to-small intake-valve lift characteristic conversion, a correction amount needed to increase the opening of throttle valve 50 is comparatively small (i.e., a somewhat large opening, slightly increased from a middle opening). Thus, it is easy to suppress a torque shock.

On the other hand, in a mode-transition (mode-switching) to the partly-inactive cylinder operating mode subsequently to the middle-to-small intake-valve lift characteristic conversion, the correction amount needed to increase the opening of throttle valve 50 becomes large, but there is the predetermined time from the start of the middle-to-small intake-valve lift characteristic conversion to the start of the transition (mode-switching) to the partly-inactive cylinder operating mode. Due to the previously-discussed predetermined time and initiation of the correction for increasing the throttle-valve opening prior to the transition (mode-switching) to the partly-inactive cylinder operating mode, it is possible to smoothly rapidly increase the correction amount needed to increase the opening of throttle valve 50 (for instance, gradually from the somewhat large opening to a large opening) without momentarily increasing the correction amount.

In this manner, in the process that shifts from the operating condition (2) of the map of FIG. 4 to the operating condition (3), the occurrence of torque shock can be effectively suppressed. By the way, suppose that the transition (mode-switching) to the partly-inactive cylinder operating mode is initiated prior to the middle-to-small intake-valve lift characteristic conversion. This means that the correction for increasing the opening of throttle valve 50 has to be momentarily executed. Actually, there is a time lag when correct the throttle-valve opening. Owing to such a time lag, a torque shock is apt to occur.

Also, suppose that the middle-to-small intake-valve lift characteristic conversion and the transition (mode-switching) to the partly-inactive cylinder operating mode are initiated simultaneously with each other. Intake-side variable valve lift (VVL) mechanism 7 used for the middle-to-small intake-valve lift characteristic conversion and each of intake-side cylinder cutoff mechanism 5 and exhaust-side cylinder cutoff mechanism 6 for the transition (mode-switching) to the partly-inactive cylinder operating mode use the same hydraulic pressure (the same switching energy) produced by the oil pump 20 common to these mechanisms 5-7. Thus, there is an increased tendency for the mode-switching/conversion response to be deteriorated. Additionally, owing to slight fluctuations in the mode-switching/conversion response, there is a possibility that the transition to the partly-inactive cylinder operating mode is undesirably initiated prior to the middle-to-small intake-valve lift characteristic conversion, and thus there is a risk of the occurrence of torque shock as previously discussed. In contrast to the above, in the VVA apparatus of the embodiment, the transition to the partly-inactive cylinder operating mode is initiated only upon expiration of the predetermined time delay from the starting point of the middle-to-small intake-valve lift characteristic conversion. Hence, it is possible to certainly avoid such a risk that the mode-transition to the partly-inactive cylinder operating mode is undesirably initiated prior to the middle-to-small intake-valve lift characteristic conversion.

Furthermore, further effects, obtained by the VVA apparatus of the embodiment, are hereunder explained.

In the default mode that no action of hydraulic pressure (no switching energy for mode-switching/conversion) from oil pump 20 to each of the cylinder cutoff switching valve 22 for cylinder cutoff mechanisms 5-6 and the intake-side variable lift switching valve 36 for VVL mechanism 7, these mechanisms 5-7 are put in their middle valve lift characteristic modes (i.e., L_{I}3, L_{E}1, L_{E}1, L_{I}2). In other words, in the default mode, the VVA system is configured to be placed into a mechanically stable operating mode (in other words, a mechanical fail-safe operating mode). Hereupon, the #1-cylinder middle valve lift L_{I}3 is equivalent to a valve-lift characteristic that intake valve closure timing (IVC) of each of intake valves 1, 1 is controlled to a slightly phase-retarded timing value ABDC at which a charging efficiency becomes high at low-speed operation. In a similar manner, the #2-cylinder middle valve lift L_{I}2 is equivalent to a prescribed valve-lift characteristic that intake valve closure timing (IVC) of each of intake valves 2, 2 is controlled to a slightly phase-retarded timing value ABDC at which a charging efficiency becomes high at low-speed operation.

Therefore, during an engine startup period, the VVA system is configured such that intake valves 1, 1, 2, 2 of all engine cylinders (i.e., both of the #1-cylinder and the #2-cylinder in the shown embodiment) are operated at the same middle valve lift amount L_{I}2=L_{I}3 in advance before the engine is cranked. That is, from the initial part of cranking, intake valves 1, 1, 2, 2 of all engine cylinders are operated at the prescribed valve-lift characteristic (L_{I}2=L_{I}3) having a high intake-air charging efficiency, thereby improving the startability.

Additionally, even in the presence of a VVA-system failure such as breaking of electric systems of the cylinder cutoff switching valve 22 and the intake-side variable lift switching valve 36 and/or oil leakage in the hydraulic system, as a default mode, the VVA system is configured to be placed into a mechanically stable operating mode (in other words, a mechanical fail-safe operating mode) at which mechanisms 5-7 are mechanically held in their middle valve lift characteristic modes (i.e., L_{I}3, L_{E}1, L_{I}2), thus ensuring a good startability from the initial part of cranking. As discussed above, the VVA system has a mechanical fail-safe function.

Additionally, as appreciated from comparison between the two different operating conditions (2)-(3) shown in FIG. 5, in the shown embodiment, regarding a middle valve-lift characteristic of a given middle valve lift L_{I}2 and a small valve-lift characteristic of a given small valve lift L_{I}1 of each of the #2-cylinder intake valves 2, 2, the cam profiles of middle-lift cam 25 and each of small-lift cams 26, 26 are configured or contoured such that intake valve open timing (IVO) of each of intake valves 2, 2 is set to an almost fixed (constant) timing value.

That is, as appreciated from comparison between the two different operating conditions (2)-(3) shown in FIG. 5, even when the middle-to-small intake-valve lift characteristic conversion from the given middle valve lift L_{I}2 into the given small valve lift L_{I}1 occurs, intake valve open timing (IVO) of each of intake valves 2, 2 is kept substantially at the same fixed timing value, and thus there is a less valve-overlap change. Hence, during the middle-to-small intake-valve lift characteristic conversion, it is possible to suppress a change in internal EGR (exhaust gas recirculation) which may occur due to a valve-overlap change, thereby effectively suppressing a transient engine performance from becoming unstable due to a transient internal EGR change.

By the way, a variable phase control mechanism (i.e., a variable valve timing control (VTC) mechanism) may be added and combined with the three mechanisms 5-7. According to the combined system of the three mechanism 5-7 and the VTC mechanism, a negative valve overlap can be produced by controlling (shifting) the phase of each of intake valves 1, 1, 2, 2 toward the phase-retard side during an idling period (see the operating condition (1) of FIG. 5). Hence, in-cylinder residual gas (i.e., internal EGR) can be more greatly reduced, thereby more greatly improving the idling stability. Also, according to the combined system of the three mechanism 5-7 and the VTC mechanism, regarding the maximum torque characteristic corresponding to the operating condition (8) of FIG. 4, by phase-retard control of the phase of each of intake valves 1, 1, 2, 2 via the VTC mechanism in concert with an increase in engine speed, it is possible to phase-retard intake valve closure timing (IVC) of each of intake valves 1, 1, 2, 2 to a sufficiently phase-retarded timing value after BDC. Hence, it is possible to satisfactorily increase the charging efficiency in a high-speed range, thus improving the maximum engine power output.

Moreover, due to individual differences of cam profiles of mechanisms 5 and 7 manufactured, in the presence of a deviation of a starting point of each of the cam profiles (in particular, a position of formation of the first part of the opening ramp of each of the cam profiles (e.g., middle-lift cam 9, middle-lift cam 25 and each of small-lift cams 26, 26) from a desired point (a desired formation position), even when switching between two different valve lift amounts, it is possible to hold intake valve open timing (IVO) of each intake valve at an almost fixed (constant) timing value by phase-control of the VTC mechanism. This improves the degree of freedom for the cam-profile setting.

The control flow executed by the controller 24 is hereunder explained in reference to the flowchart of FIG. 7

First, at step S1, the current engine operating condition is determined based on latest up-to-date information from the engine/vehicle sensors, and then the current (up-to-date) engine operating condition is read.

At step S2, a check is made to determine whether the current engine operating condition exists within the “A” range. When the answer to step S2 is in the negative (NO), that is, when the current engine operating condition is out of the “A” range, the routine returns to step S1. Conversely when the answer to step S2 is in the affirmative (YES), that is, when the current engine operating condition exists with the “A” range, the routine proceeds to step S3.

At step S3, a check is made to determine whether the current engine operating condition shifts into the “AB” boundary line. When the answer to step S3 is negative (NO), that is, when the current engine operating condition does not yet shift into the “AB” boundary line, the routine returns to step S1. Conversely when the answer to step S3 is affirmative (YES), that is, when the current engine operating condition has shifted into the “AB” boundary line (immediately before the transition from the operating condition (2) to the intermediate operating condition (a) in the operating-mode-switching sequence chart of FIG. 6), the routine proceeds to step S4.

At step S4, a control current (a high (ON) current value) is outputted from the controller 24 to the variable lift switching valve 36, so as to convert (reduce) the lift characteristic of each of the #2-cylinder intake valves 2, 2 from a given middle valve lift L_{I}2 to a given small valve lift L_{I}1. Thus, as appreciated from the intermediate operating condition (a) of FIG. 6, by the use of the variable lift switching valve 36 shifted to the working-fluid supply mode (the hydraulic-pressure supply mode), switching from the given middle valve lift L_{I}2 to the given small valve lift L_{I}1 occurs via the intake-side variable valve lift (VVL) mechanism 7. At the same time, a control signal for increasing the opening of throttle valve 50 is generated from the controller 24, and therefore the opening of throttle valve 50 is controlled from a middle opening to a somewhat large opening.

At step S5, by means of a timer, a check is made to determine whether a predetermined time Δt has expired from the starting point of control executed at step S4 (i.e., the starting point of the middle-to-small intake-valve lift characteristic conversion control as well as the throttle-valve opening increase control). When the predetermined time Δt has not yet expired, the routine returns from step S5 back to step S4. Conversely when the predetermined time Δt has expired, the routine proceeds to step S6.

At step S6, a control signal (a control current) is outputted from the controller 24 to the cylinder cutoff switching valve 22, for the purpose of a transition to the partly-inactive cylinder operating mode (the cylinder cutoff mode). Thus, as appreciated from the operating condition (3) of FIG. 6, by the use of the cylinder cutoff switching valve 22 shifted to the working-fluid supply mode (the hydraulic-pressure supply mode), each of the #1-cylinder intake valves 1, 1 and the #1-cylinder exhaust valves 3, 3 becomes shifted to a valve-stopped mode (an inactive valve mode) via the cylinder cutoff mechanisms 5-6. At the same time, a control signal for further increasing the opening of throttle valve 50 is generated from the controller 24, and therefore the opening of throttle valve 50 is controlled from the somewhat large opening to a large opening. In this manner, a series of processes (a series of steps S1-S6) has completed, and thus one execution cycle terminates.

As discussed previously, when a transition from the operating condition (2) (i.e., “A” range, in other words, a full-cylinder/intake-valve middle-lift mode) of the control map of FIG. 4 and the characteristic diagram of FIG. 5 to the operating condition (3) (i.e., “B” range, in other words, a partly-inactive cylinder/intake-valve small-lift mode) occurs, according to the mode-switching sequence of FIG. 6, prior to the transition (mode-switching) of the #1-cylinder to the partly-inactive cylinder operating mode, the middle-to-small intake-valve lift characteristic conversion of each of the #2-cylinder intake valves 2, 2 is initiated. Next, the transition of the #1-cylinder to the partly-inactive cylinder operating mode (the cylinder cutoff mode) is initiated. Hence, as discussed previously, the occurrence of torque shock can be effectively suppressed. Additionally, under a specific condition where the #1-cylinder is held in its cylinder cutoff mode and each of the #2-cylinder intake valves 2, 2 is operated at a given small valve-lift characteristic of a given small valve lift L_{I}1, it is possible to sufficiently reduce a pumping loss as well as an overall friction of the valve operating system, thereby sufficiently improve fuel economy. These principles are stated above.

### Second Embodiment

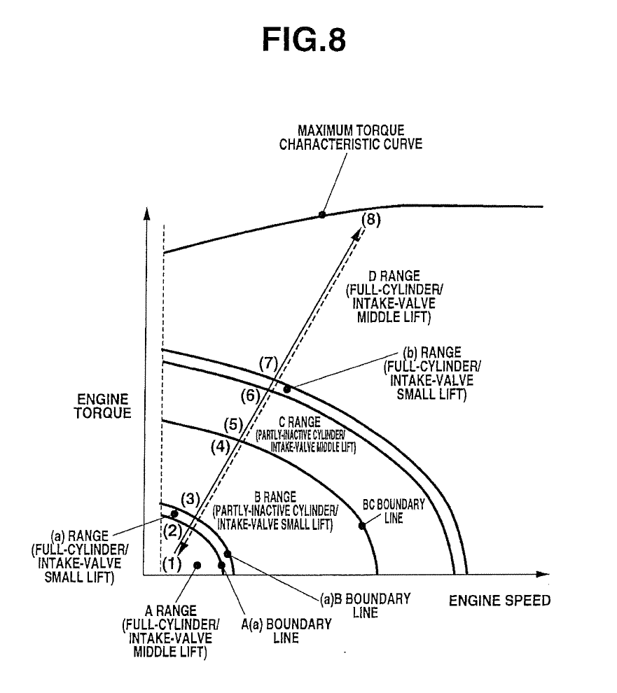

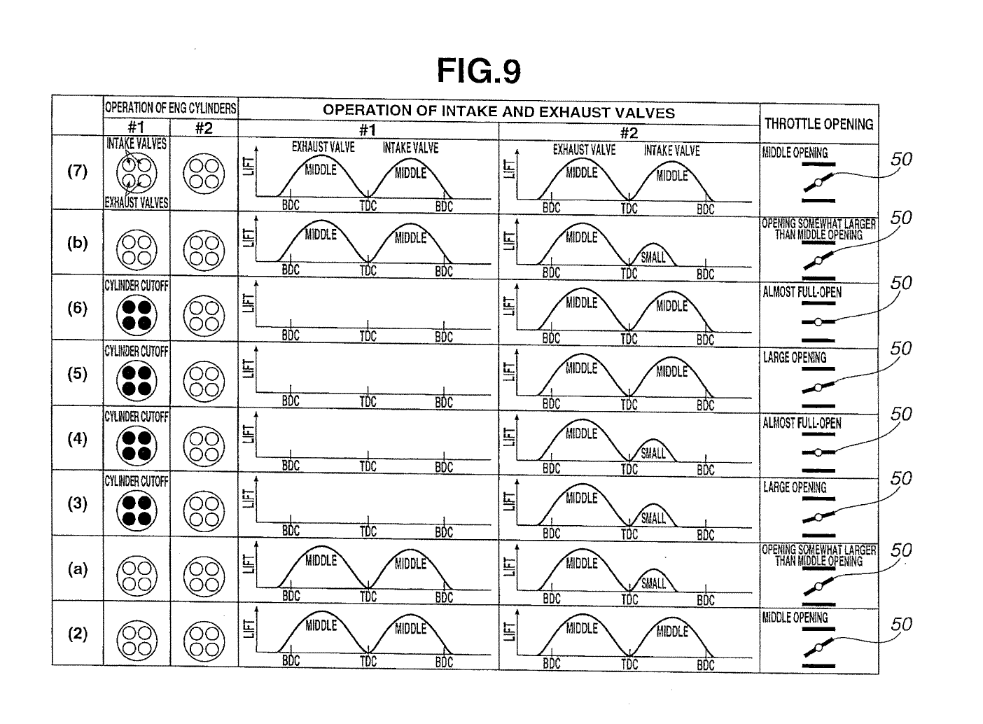

Referring now to FIGS. 8-9, there are shown the VVA system control map used for the controller incorporated in the VVA apparatus of the second embodiment and the characteristic diagram concerning valve lift characteristics and throttle-valve opening characteristics in a full-cylinder operating mode and in a partly-inactive cylinder operating mode in the second embodiment. As appreciated from comparison between the map of FIG. 4 and the map of FIG. 8, the second embodiment is slightly different from the first embodiment in that the intermediate operating condition (a) (or the intermediate operating mode (a)), shown in the operating-mode-switching sequence chart of FIG. 6 in a transition from the “A” range (i.e., the operating condition (2)) to the “B” range (i.e., the operating range (3)), is given between the “A” range (i.e., the operating condition (2)) and the “B” range (i.e., the operating condition (3)) in the form of a preprogrammed map area.

Hence, when a (2)-to-(3) transition (a shift) from the condition (2) to the condition (3) occurs, the VVA apparatus of the first embodiment requires advanced high-precision transient control. In contrast, in the case of the VVA apparatus of the second embodiment, the intermediate range (a) is merely given as a preprogrammed map area. This simplifies transient control, thus effectively reducing the control load.

Additionally, as a further map area, an intermediate range (b) (i.e., a full-cylinder/intake-valve small-lift mode) is given or provided between the operating condition (6) (i.e., “C” range, in other words, a partly-inactive cylinder/intake-valve middle-lift mode) and the operating condition (7) (i.e., “D” range, in other words, a full-cylinder/intake-valve middle-lift mode). As appreciated from valve lift characteristics of the intermediate range (b) shown in the characteristic diagram of FIG. 9, for the same opening of throttle valve 50, the intake-air charging efficiency, obtained in the intermediate range (b), is larger than that obtained in the operating condition (6) because of the full-cylinder operating mode of the intermediate range (b). Also, for the same throttle-valve opening, the intake-air charging efficiency, obtained in the intermediate range (b), is less than that obtained in the operating condition (7) because of each of the #2-cylinder intake valves 2, 2 operated at a small valve-lift characteristic of a given small valve lift amount L_{I}1 in the intermediate range (b). Hence, by virtue of the intermediate range (b) interleaved between the operating condition (6) (i.e., “C” range) and the operating condition (7) (i.e., “D” range), it is possible to effectively suppress, absorb or alleviate an undesirable torque change (an undesirable torque shock).

By the way, for the purpose of suppressing a torque shock (or a rapid torque change) occurring during a (6)-to-(7) transition, the opening of throttle valve 50 may be corrected momentarily by high-precision transient throttle-valve opening control. By virtue of the intermediate range (b) interleaved between the conditions (6)-(7), the VVA apparatus of the second embodiment eliminates the necessity of using such high-precision transient throttle-valve opening control.

Furthermore, in the case of the VVA apparatus of the second embodiment, the intermediate range (b) as well as the intermediate range (a) is merely given as a preprogrammed map area. This simplifies transient control, thus effectively reducing the control load.

### Third Embodiment

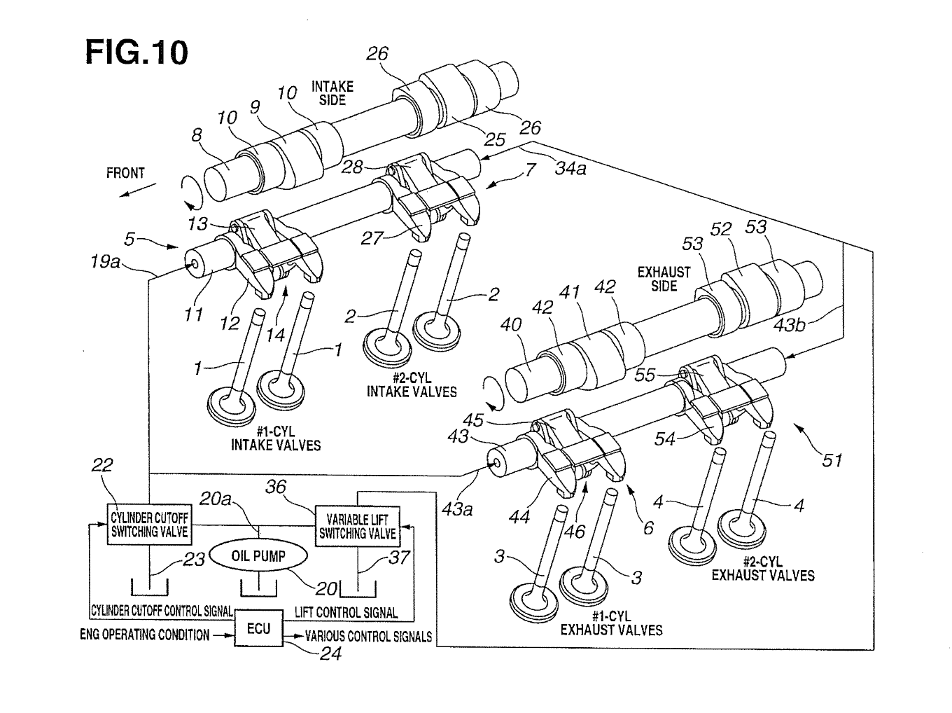

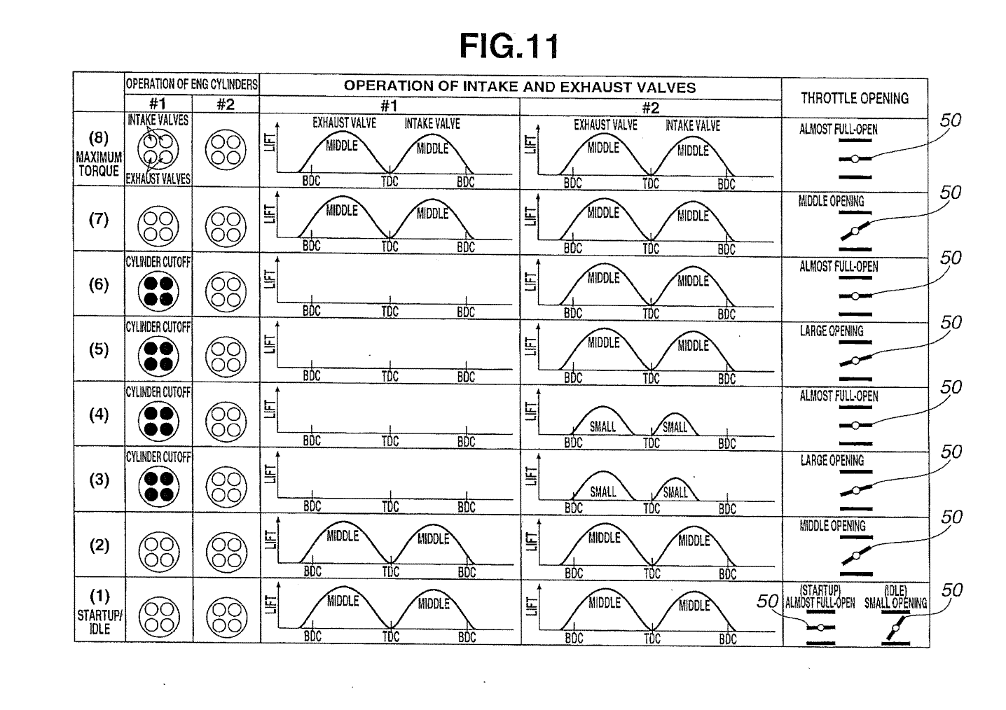

Referring now to FIGS. 10-11, there are shown the VVA system configuration of the third embodiment and the characteristic diagram concerning valve lift characteristics and throttle-valve opening characteristics in a full-cylinder operating mode and in a partly-inactive cylinder operating mode in the third embodiment. The fundamental construction/configuration of intake-side cylinder cutoff mechanism 5 (the intake-valve stop mechanism), exhaust-side cylinder cutoff mechanism 6 (the exhaust-valve stop mechanism), and intake-side variable valve lift (VVL) mechanism 7, incorporated in the VVA apparatus of the third embodiment, is similar to the first embodiment shown in FIG. 1. The third embodiment is slightly different from the first embodiment in that in the third embodiment an exhaust-side variable valve lift (VVL) mechanism 51 is installed on the #2-cylinder side for variably control or adjust a valve lift amount of each of exhaust valves 4, 4, instead of using a fixed valve lift characteristic mechanism (i.e., the middle-lift cam 49 and the fixed cam-follower equipped swing arm 47).

Exhaust-side variable valve lift (VVL) mechanism 51 is similar to intake-side variable valve lift (VVL) mechanism 7 shown in FIGS. 3A-3B in construction. The construction of exhaust-side variable valve lift (VVL) mechanism 51 is hereunder described briefly.

Exhaust-side variable valve lift (VVL) mechanism 51 is comprised of a middle-lift cam 52, a pair of small-lift cams 53, 53, a main rocker arm 54, a sub-rocker arm 55, a lost-motion mechanism, a spring-loaded lever member and its return spring, and a hydraulic plunger and its coil spring. Small-lift cams 53, 53 are located on both sides of middle-lift cam 52 integrally formed on the outer periphery of exhaust camshaft 40. Main rocker arm 54 is pivotably supported on the rocker shaft 43 and formed integral with a pair of cam-follower portions. The cam-follower portions are configured to be conformable to respective axial positions of small-lift cams 53, 53 and also configured such that the lower ends of the tips of the cam-follower portions are kept in abutted-engagement with the respective valve stem ends of exhaust valves 4, 4. Sub-rocker arm 55 is mounted on the rocker shaft 43 so as to be conformable to the axial position of middle-lift cam 52 and configured to be operated in a lost-motion mode. The lost-motion mechanism is installed in the main rocker arm 54 for biasing the sub-rocker arm 55 toward the middle-lift cam 52. The lever member is pivotably supported on a support shaft fixedly connected to the main rocker arm 54. The lever member is configured to permit (enable) movement of sub-rocker arm 55 in synchronism with a rocking motion of main rocker arm 54 by movement of the lever member into engagement with a jaw-like lower end of sub-rocker arm 55 and to inhibit (disable) movement of sub-rocker arm 55 in synchronism with a rocking motion of main rocker arm 54 by movement of the lever member out of engagement with the jaw-like lower end of sub-rocker arm 55. The hydraulic plunger and its coil spring installed in the plunger under preload are provided for movement of the lever member into and out of engagement with the lower end of sub-rocker arm 55.

The previously-discussed hydraulic plunger has a pressure-receiving flange on which a hydraulic pressure of working fluid, supplied from oil pump 20 through an axial hydraulic passage 43b formed in the rocker shaft 43 and a hydraulic passage formed in the main rocker arm 54 into a hydraulic chamber defined on the outer periphery of the hydraulic plunger, acts. In the presence of a hydraulic-pressure supply from oil pump 20 through the hydraulic passages to the hydraulic chamber, a retreating movement of the hydraulic plunger apart from the lever member occurs. In the absence of the hydraulic-pressure supply, an advancing movement of the hydraulic plunger toward the lever member occurs owing to a spring force of the coil spring. The hydraulic passage 43b of exhaust-side variable valve lift (VVL) mechanism 51 is communicated with the hydraulic passage 34a of intake-side variable valve lift (VVL) mechanism 7. That is to say, the hydraulic circuit system is configured such that intake-side variable valve lift (VVL) mechanism 7 and exhaust-side variable valve lift (VVL) mechanism 51 are hydraulically operated and controlled simultaneously by the same hydraulic pressure (the same switching energy) fed through the use of the variable lift switching valve 36 common to the two VVL mechanisms 7 and 51.

That is, the common variable lift switching valve 36 is configured to simultaneously accomplish (i) switching between fluid-communication between hydraulic passage 43b and the drain passage 23 and fluid-communication between hydraulic passage 43b and the discharge passage 20a as well as (ii) switching between fluid-communication between hydraulic passages 34a-34b and the drain passage 23 and fluid-communication between hydraulic passages 34a-34b and the discharge passage 20a.

Concretely, when the variable lift switching valve 36 is switched to the working-fluid drain mode that there is no hydraulic-pressure supply through the variable lift switching valve 36 to the exhaust-side variable valve lift (VVL) mechanism 51, each of the #2-cylinder exhaust valves 4, 4 is shifted to a middle valve-lift characteristic mode of a given middle valve lift L_{E}1 by the use of middle-lift cam 52. Conversely when the variable lift switching valve 36 is switched to the working-fluid supply mode that there is a hydraulic-pressure supply through the variable lift switching valve 36 to the exhaust-side variable valve lift (VVL) mechanism 51, each of the #2-cylinder exhaust valves 4, 4 is shifted to a small valve-lift characteristic mode of a given small valve lift L_{E}2 by the use of small-lift cams 53, 53.

As discussed above, the VVA apparatus of the third embodiment is configured to enable simultaneous switching of intake-side variable valve lift (VVL) mechanism 7 and exhaust-side variable valve lift (VVL) mechanism 51 by the same hydraulic pressure (the same switching energy) fed through the use of the common variable lift switching valve 36. This enables the more greatly simplified system. Additionally, a valve lift of each of the #2-cylinder intake valves 2, 2 and a valve lift of each of the #2-cylinder exhaust valves 4, 4 can be switched simultaneously with each other, thus effectively prevent or suppress a time difference between conversion of the lift characteristic of each of the #2-cylinder intake valves 2, 2 and conversion of the lift characteristic of each of the #2-cylinder exhaust valves 4, 4 from occurring. This contributes to the improved and stabilized transient performance during the lift-characteristic conversion.

As compared to the operation and effects of the first embodiment, the VVA apparatus of the third embodiment can provide a further technical feature such that, as appreciated from the (3)-(4) operating range shown in the characteristic diagram of FIG. 5, in a small valve-lift range (i.e., the “B” range) of each of the #2-cylinder intake valves 2, 2 during the partly-inactive cylinder operating mode, a valve lift of each of exhaust valves 4, 4 of the working (active) #2-cylinder can be converted to a given small valve lift L_{E}2.

By virtue of conversion of the lift characteristic of each of exhaust valves 4, 4 to the small valve-lift characteristic of the given small valve lift L_{E}2, exhaust valve open timing (EVO) of each of exhaust valves 4, 4 is phase-retarded to the vicinity of BDC. Hence, combustion pressure can be effectively utilized as expansion work to the vicinity of the piston bottom dead center (BDC), thereby more greatly reducing a fuel consumption rate.

Additionally, exhaust valve closure timing (EVC) of each of exhaust valves 4, 4 is controlled to a phase-advanced timing value before the piston top dead center (TDC). That is, by virtue of so-called early exhaust valve closure timing (EVC), it is possible to create a properly-controlled high-temperature in-cylinder residual gas (high-temperature recirculated exhaust gas of internal EGR) at the piston TDC, thereby improving fuel economy.

Internal EGR created during a valve overlapping period tends to be affected by intake and/or exhaust pulsations, and thus the amount of internal EGR tends to fluctuate. Additionally, regarding the internal EGR created during the valve overlapping, the recirculated exhaust gas temperature (the inert gas temperature) tends to fall, since the recirculated exhaust gas, returned back to the intake system once, is drawn again into the engine cylinder. In contrast, the internal EGR, created at the early EVC, is scarcely affected by intake and/or exhaust pulsations in theory, and hence there is a less fluctuation in the amount of internal EGR. Also, owing to the early EVC, it is possible to hold the recirculated exhaust gas (the inert gas) in the engine cylinder before the recirculated exhaust gas is exhausted from the engine cylinder (the combustion chamber). Hence, high-temperature recirculated exhaust gas of internal EGR can be held in the engine cylinder, thereby improving combustion and thus more greatly improving fuel economy.

Accordingly, according to the VVA apparatus of the third embodiment, it is possible to increase the amount of internal EGR while suppressing fluctuations in the amount of internal EGR. Furthermore, owing to the previously-discussed high-temperature recirculated exhaust gas of internal EGR, it is possible to improve combustion, thereby more greatly improve fuel economy in the partly-inactive cylinder/intake-valve small-lift mode (i.e., the “B” range corresponding to the (3)-(4) operating range, in other words, the partly-inactive cylinder/intake-valve small-lift range).

### Fourth Embodiment

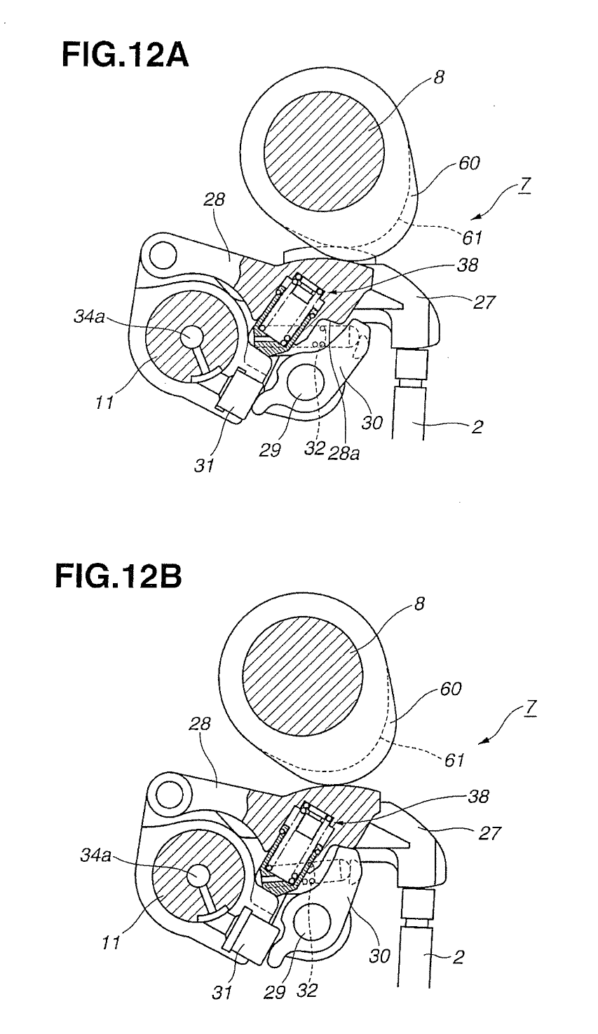

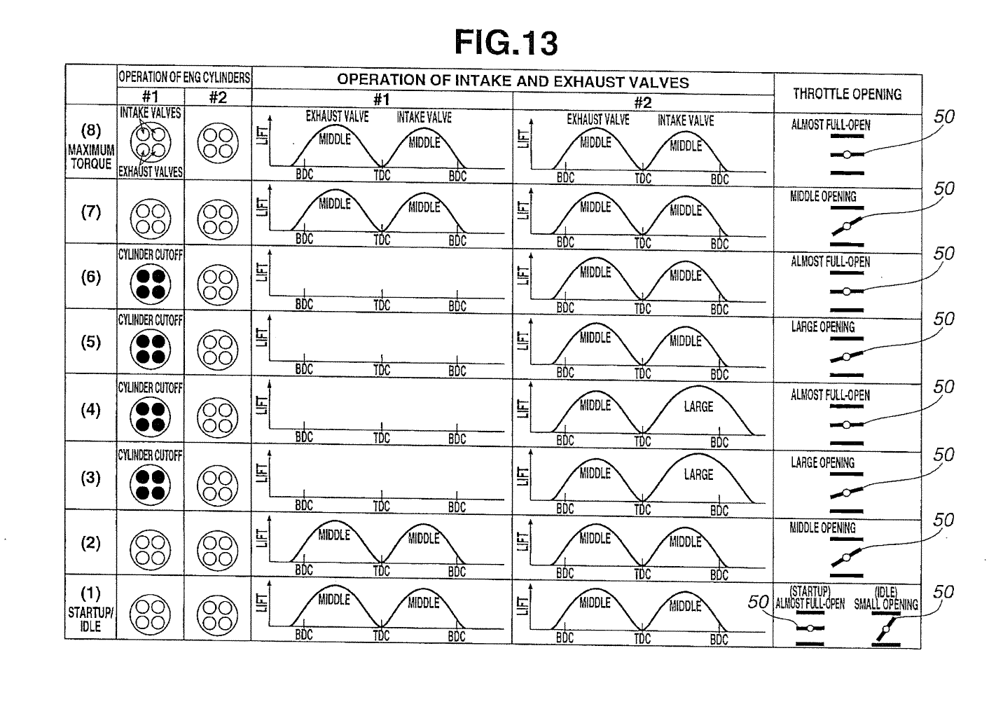

Referring now to FIGS. 12A-12B and 13, there are shown the #2-cylinder intake-side VVL mechanism 7 incorporated in the VVA apparatus of the fourth embodiment and the characteristic diagram concerning valve lift characteristics and throttle-valve opening characteristics in a full-cylinder operating mode and in a partly-inactive cylinder operating mode in the fourth embodiment. As appreciated from comparison between the cross sections of FIGS. 3A-3B (the first embodiment) and the cross sections FIGS. 12A-12B (the fourth embodiment), the fourth embodiment is slightly different from the first embodiment in that in the fourth embodiment the construction of intake-side VVL mechanism 7 (in particular, the construction of hydraulic plunger 31) and the cam profile of each cam integrally formed on the intake camshaft 8 are somewhat modified.

As shown in FIGS. 12A-12B, a large-lift cam 60 is configured to be conformable to the position of the #2-cylinder and integrally formed on the intake camshaft 8 so as to be kept in sliding-contact with the sub-rocker arm 28. A pair of middle-lift cams 61, 61 are located on both sides of large-lift cam 60 and configured to be kept in sliding-contact with respective cam-follower portions integrally formed on the main rocker arm 27.

A valve lift amount L_{I}2 of each of the #2-cylinder intake valves 2, 2, produced by the middle-lift cams 61, 61, is set to be equal to the valve lift amount the given middle valve lift amount L_{I}3 of each of the #1-cylinder intake valves 1, 1, produced by the middle-lift cam 9 of intake-side cylinder cutoff mechanism 5. On the other hand, a valve lift amount L_{I}4 of each of the #2-cylinder intake valves 2, 2, produced by the large-lift cam 60, is set to be relatively greater than each of the given middle valve lift amount L_{I}2 and the given middle valve lift amount L_{I}3. Also, in a similar manner to the first embodiment, in the fourth embodiment the sub-rocker arm 28 is forced or biased toward the large-lift cam 60 by means of the lost motion mechanism 38.

By the way, a default mode of the VVA apparatus of the fourth embodiment is reversed as compared to the first embodiment. During a default mode, the VVA apparatus of the fourth embodiment is configured such that each of the #2-cylinder intake valves 2, 2 is operated (opened or closed) at a relatively smaller valve lift (that is, the given middle valve lift amount L_{I}2) by means of the middle-lift cams 61, 61.

The operation of the VVA apparatus (in particular, the #2-cylinder intake-side VVL mechanism 7) of the fourth embodiment is hereunder described in reference to FIGS. 12A-12B. As clearly seen from the cross sections of FIGS. 12A-12B, hydraulic plunger 31 is not formed with a pressure-receiving flange. In other words, hydraulic plunger 31 is formed as a cylindrical plunger. When the variable lift switching valve 36 is operated, responsively to a control current (ON signal) from controller 24, in a working-fluid supply mode (a hydraulic-pressure supply mode) that there is a hydraulic-pressure supply through the variable lift switching valve 36 to the intake-side variable lift mechanism 7, an advancing movement of hydraulic plunger 31 toward the lower tab-like portion of lever member 30 occurs and thus the lever member 30 rotates anticlockwise. As a result, the top end of the lever member 30 is brought into engagement with the jaw-like lower end 28a of sub-rocker arm 28 so as to permit movement of sub-rocker arm 28 in synchronism with a rocking motion of main rocker arm 27 through the lever member 30. Accordingly, as shown in FIG. 12B, each of intake valves 2, 2 is operated (opened or closed) in a large valve lift characteristic mode of the given large valve lift amount L_{I}4 by means of a cam profile of the large-lift cam 60.

Conversely when the variable lift switching valve 36 is operated, responsively to a control current (OFF signal) from controller 24, in a working-fluid drain mode that there is no hydraulic-pressure supply through the variable lift switching valve 36 to the intake-side variable lift mechanism 7, a retreating movement of hydraulic plunger 31 apart from the lower tab-like portion of lever member 30 occurs and thus the lever member 30 rotates clockwise. As a result, the top end of the lever member 30 is brought out of engagement with the jaw-like lower end 28a of sub-rocker arm 28 such that sub-rocker arm 28 is put into lost motion via the lost-motion mechanism 38. Accordingly, as shown in FIG. 12A, each of intake valves 2, 2 is operated (opened or closed) in a middle valve lift characteristic mode of the given middle valve lift amount L_{I}2 by means of a cam profile of each of the middle-lift cams 61, 61 via the respective cam-follower portions of main rocker arm 27.

That is to say, during a default mode, the VVA apparatus of the first embodiment is configured such that each of the #2-cylinder intake valves 2, 2 is operated at a relatively larger valve lift (that is, the given middle valve lift amount L_{I}2). In contrast, during a default mode, the VVA apparatus of the fourth embodiment is configured such that each of the #2-cylinder intake valves 2, 2 is operated at a relatively smaller valve lift (that is, the given middle valve lift amount L_{I}2). In terms of the absolute value of a valve lift amount, the relative larger valve lift (i.e., the given middle valve lift amount L_{I}2) produced by the VVA apparatus of the first embodiment in the default mode and the relatively smaller valve lift (i.e., the given middle valve lift amount L_{I}2) produced by the VVA apparatus of the fourth embodiment in the default mode are equal to each other.

Conversely during an anti-default mode, the VVA apparatus of the first embodiment is configured such that each of the #2-cylinder intake valves 2, 2 is operated at a relatively smaller valve lift (that is, the given small valve lift amount L_{I}1). In contrast, during an anti-default mode, the VVA apparatus of the fourth embodiment is configured such that each of the #2-cylinder intake valves 2, 2 is operated at a relatively larger valve lift (that is, the given large valve lift amount L_{I}4).

The valve lift characteristics, obtained by the VVA apparatus of the fourth embodiment, are hereunder described in reference to FIG. 13. As appreciated from comparison between valve lift characteristics of the first embodiment of FIG. 5 and valve lift characteristics of the fourth embodiment of FIG. 13, the fourth embodiment differs from the first embodiment about lift characteristics in the “B” range (i.e., the (3)-(4) operating range shown in the characteristic diagram), corresponding to a comparatively (somewhat) low-speed low-load range. In the first embodiment, the engine is operated at a partly-inactive cylinder/intake-valve small-lift mode (with the #1-cylinder held in the inactive (zero-lift) valve mode and with the #2-cylinder intake valves 2, 2 each operated at a small valve-lift characteristic of a given small valve lift L_{I}1) in the “B” range (i.e., the (3)-(4) operating range of FIG. 5). In contrast, in the fourth embodiment, the engine is operated in a partly-inactive cylinder/intake-valve large-lift mode (with the #1-cylinder held at the inactive (zero-lift) valve mode and with the #2-cylinder intake valves 2, 2 each operated at a large valve-lift characteristic of a given large valve lift L_{I}4) in the “B” range (i.e., the (3)-(4) operating range of FIG. 13).

As shown in the characteristic diagram of FIG. 13, during the partly-inactive cylinder/intake-valve large-lift mode, intake valve closure timing (IVC) of each of intake valves 2, 2 is controlled to a considerably phase-retarded timing value after a piston BDC. Hence, in a similar manner to the given small valve lift L_{I}1 of the first embodiment at which intake valve closure timing (IVC) of each of the #2-cylinder intake valves 2, 2 is controlled to a phase-advanced timing BBDC, in the case of the given large valve lift L_{I}4 of the fourth embodiment at which intake valve closure timing (IVC) is controlled to a considerably phase-retarded timing ABDC, the charging efficiency of intake air entering the engine cylinder tends to reduce. To compensate for the reduced intake-air charging efficiency, the opening of throttle opening 50 has to be so increased as to produce a desired engine torque. Accordingly, a decrease in intake manifold pressure (a vacuum or a negative pressure) occurs, thereby reducing a pumping loss, and consequently improving fuel economy.

On one hand, owing to the increased valve lift amount (i.e., the given large valve lift L_{I}4) of each of the #2-cylinder intake valves 2, 2, an increase in the overall friction of the valve operating system occurs. Such an increased friction of the valve operating system serves as an unfavorable factor that deteriorates fuel economy. On the other hand, owing to the increased valve lift amount (i.e., the given large valve lift L_{I}4), intake valve closure timing (IVC) of each of intake valves 2, 2 is controlled to a considerably phase-retarded timing value ABDC, thereby permitting air, which has been drawn into the engine cylinder once, to blow back to the intake manifold. This promotes good mixing of gas in the intake manifold. As a result of this, combustion can be improved. That is, by virtue of the blow-back gas, created by IVC controlled to a considerably phase-retarded timing value ABDC (so-called late intake valve closure timing), it is possible to improve fuel economy.

Additionally, as a synergistic effect of the increased valve lift amount (i.e., the given large valve lift L_{I}4) and the considerably phase-retarded IVC ABDC (so-called late IVC), a large amount of fresh air of comparatively low temperatures can be drawn into the engine cylinder and also the air, which has been drawn into the engine cylinder once, can be blown back to the intake manifold. This contributes to the in-cylinder cooling and better detonation control, thereby effectively suppressing knocking. In other words, this enables advanced ignition timing. By virtue of the advanced ignition timing, it is possible to improve fuel economy. Accordingly, as a whole, in a similar manner to the first embodiment, the VVA apparatus of the fourth embodiment can sufficiently improve a fuel-consumption reducing effect, even during the partly-inactive cylinder/intake-valve large-lift mode (with the #1-cylinder held in the inactive valve mode and with the #2-cylinder intake valves 2, 2 each operated at a large valve-lift characteristic of a given large valve lift L_{I}4) in the “B” range (the (3)-(4) operating range of FIG. 13).

### Fifth Embodiment

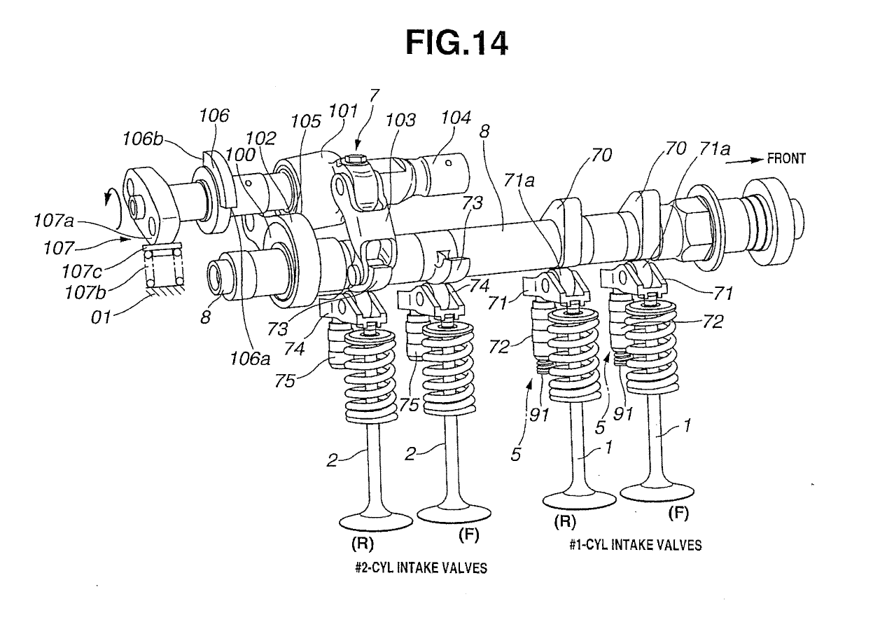

Referring to FIG. 14 there is shown the intake-side cylinder cutoff mechanism and the intake-side variable valve lift mechanism incorporated in the VVA apparatus of the fifth embodiment. Intake-side cylinder cutoff mechanism 5 and exhaust-side cylinder cutoff mechanism 6 are similar to each other in construction. For the sake of simplicity, only the intake-side cylinder cutoff mechanism 5 is shown in FIG. 14, but the exhaust-side cylinder cutoff mechanism 6 is omitted.

As appreciated from the perspective view of FIG. 14, the fifth embodiment differs from the first embodiment, in that the construction of each of intake-side cylinder cutoff mechanism 5, exhaust-side cylinder cutoff mechanism 6, and intake-side VVL mechanism 7 is modified.

First of all, the intake-side valve operating mechanism is briefly explained. On the #1-cylinder side, two rotating cams 70, 70 are formed integral with the outer periphery of intake camshaft 8. Also provided is a pair of swing arms 71, 71 configured to be conformable to respective axial positions of rotating cams 70, 70. Swing arms 71, 71 are designed to rock by respective rotary motions of rotating cams 70, 70, causing the intake valves 1, 1 to open or close. Also provided is a pair of hydraulic lash adjusters 72, 72 (serving as a pair of pivots) supported on a cylinder head 01 and configured to provide zero clearance (zero valve lash) between each swing arm 71 and each intake valve 1.

On the #2-cylinder side, two rockable cams 73, 73 (constructing part of the VVL mechanism of the fifth embodiment described later) are rockably installed and supported on the outer periphery of intake camshaft 8 via respective bearings. Also provided is a pair of swing arms 74, 74 configured to be conformable to respective axial positions of rockable cams 73, 73. Swing arms 74, 74 are designed to rock by respective oscillating motions of rockable cams 73, 73, causing the intake valves 2, 2 to open or close. Also provided is a pair of hydraulic lash adjusters 75, 75 (serving as a pair of pivots) supported on the cylinder head 01 and configured to provide zero clearance (zero valve lash) between each swing arm 74 and each intake valve 2.

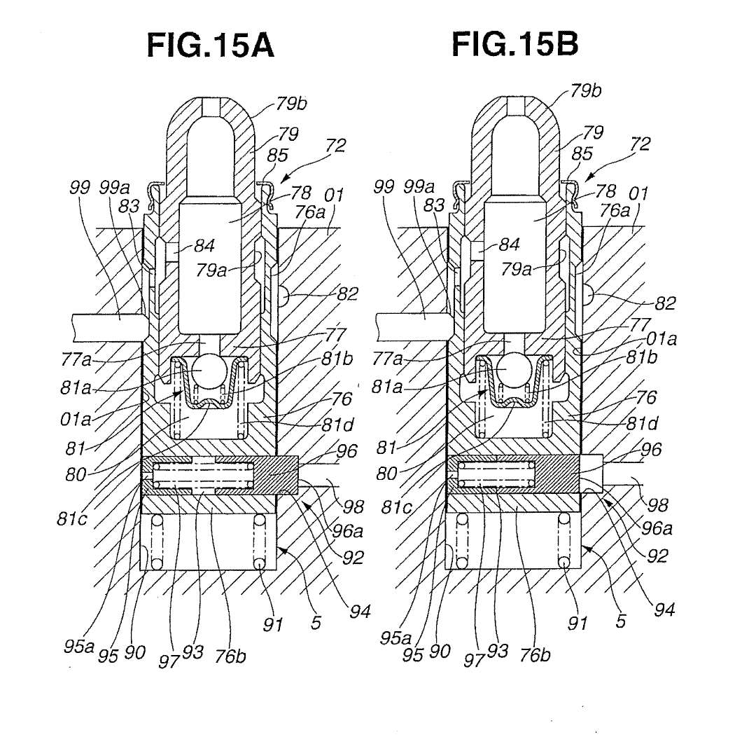

As seen from the longitudinal cross sections of FIGS. 15A-15B, the hydraulic lash adjuster pair 72, 72 constructs intake-side cylinder cutoff mechanism 5 (exactly, a lost-motion type cylinder cutoff mechanism) that provides or creates a lost-motion mode. Each of hydraulic lash adjusters 72, 72 is comprised of a cylindrical lash-adjuster body 76, a bullet-shaped plunger 79, a high-pressure chamber 80, and a check valve 81. Lash-adjuster body 76 is closed at its bottom end and retained in a cylindrical retaining hole 01a formed in the cylinder head 01. Plunger 79 is installed in the lash-adjuster body 76 in such a manner as to be movable vertically (viewing FIGS. 15A-15B) and formed, at its bottom end, integral with a partition wall 77 so as to define a reservoir chamber 78 inside of the plunger 79. High-pressure chamber 80 is defined in the bottom of lash-adjuster body 76 and configured to communicate with the reservoir chamber 78 through a communication hole 77a (an axial through hole) formed in the partition wall 77. Check valve 81 is installed in the high-pressure chamber 80 so as to permit flow in one direction (that is, working-fluid flow directed from the reservoir chamber 78 to the high-pressure chamber 80) and prevent any flow in the opposite direction. A drain hole (not shown) is also formed in the cylinder head 01 for draining working fluid accumulated in the retaining hole 01a to the exterior.

Lash-adjuster body 76 has a first annular recessed groove 76a formed in the outer peripheral surface and a first passage hole 83 (a radial through hole) through which a hydraulic passage 82 and the interior space of lash-adjuster body 76 are communicated with each other. The first passage hole 83 is formed in the cylindrical wall of the first annular recessed groove 76a as a radial through hole. Hydraulic passage 82 is formed in the cylinder head 01. The downstream end of hydraulic passage 82 is opened into the first recessed groove 76a.

The lash-adjuster body 76 of each of the #1-cylinder hydraulic lash adjusters 72, 72 is shaped as a substantially cylindrical member having a cylindrical bore closed at the bottom end. The bottom 76b of lash-adjuster body 76 of each of the #1-cylinder hydraulic lash adjusters 72, 72 is configured to further extend downward as compared to the lowermost end of the lash-adjuster body of each of the #2-cylinder hydraulic lash adjusters 75, 75.

Hydraulic passage 82 is configured to communicate with a lubricating-oil supply main oil gallery (not shown) formed in the cylinder head 01. Lubricating oil is force-fed from an oil pump (not shown) into the main oil gallery.

As clearly shown in FIGS. 15A-15B, plunger 79 has a second annular recessed groove 79a formed in the outer peripheral surface substantially at an axially center position, and a second passage hole 84 (a radial through hole) through which the first passage hole 83 and the reservoir chamber 78 are communicated with each other. The second passage hole 84 is formed in the cylindrical wall of the second annular recessed groove 79a as a radial through hole. To ensure a good slidability, the end face of the tip of bullet-shaped head 79b of plunger 79 is formed as a substantially semi-spherical protruding portion, which is kept in sliding-contact with a substantially semi-spherical recessed portion formed on the underside of one end of swing arm 71, spaced apart from the other end of swing arm 71 brought into abutted-engagement with the associated valve stem end of intake valve 1.

By the way, the maximum advancing movement (the maximum upward stroke) of plunger 79 is restricted by means of an annular snap-fit stopper 85, which is fitted onto the uppermost end of the lash-adjuster body 76.

The axial length of the second annular recessed groove 79a is dimensioned to permit continuous communication between the first passage hole 83 and the second passage hole 84 over the entire stroke range of the plunger 79, which is vertically slidable relatively to the lash-adjuster body 76.

Check valve 81 is comprised of a check ball 81a, a first coil spring Bib, a cup-shaped retainer 81c, and a second coil spring 81d. Check ball 81a is provided for opening and closing the lowermost opening end (serving as a check-valve seat) of communication hole 77a. The first coil spring 81b is provided for biasing the check ball 81a in a direction for closing of the lowermost opening end. The cup-shaped retainer 81c is provided for holding the first coil spring 81b. The second coil spring 81d is disposed between the inside bottom face of the bottom 76b of lash-adjuster body 76 and the uppermost annular flared portion of cup-shaped retainer 81c under preload for biasing the plunger 79 upward, while biasing the retainer 81c toward the partition wall 77.

When the base circle of the rotating cam (the driving cam) 70 is brought into contact with a roller 71a (described later) of swing arm 71, owing to an advancing movement (upward movement) of plunger 79, produced by the bias (the spring force) of the second coil spring 81d, hydraulic pressure in high-pressure chamber 80 becomes low and thus working fluid, fed or introduced from the hydraulic passage 82 into the retaining hole 01a, flows through the first annular recessed groove 76a, the first passage hole 83, the second annular recessed groove 79a, and the second passage hole 84 into the reservoir chamber 78. Hence, under hydraulic pressure of working fluid flown into the reservoir chamber 78, check ball 81a is forced off its seat (i.e., the lowermost opening end of communication hole 77a) against the spring force of the first coil spring Bib. With the check valve 81 kept open, the working fluid is introduced into the high-pressure chamber 80.

As a result of this, plunger 79 pushes up the one end of swing arm 71, and therefore a clearance between the rotating cam 70 and the other end of swing arm 71 and a clearance between the other end of swing arm 71 and the associated valve stem end of intake valve 1 are adjusted to zero clearance (zero valve lash) via contact of the roller 71a of swing arm 71 with the rotating cam 70.

Conversely during a lifting phase, that is, when the ramp of the rotating cam 70 comes into contact with the roller 71a of swing arm 71, plunger 79 is forced downward and thus a retreating movement (downward movement) of plunger 79 occurs so as to produce a rise in hydraulic pressure in high-pressure chamber 80. Hence, the working fluid (hydraulic oil) in the high-pressure chamber 80 tends to leak out of the clearance space defined between plunger 79 and lash-adjuster body 76. As a result, a slight downward stroke (so-called leak-down) of plunger 79 occurs. After this, when a transition from the lifting phase of rotating cam 70 to the base-circle phase occurs, as discussed previously, owing to an advancing movement (upward movement) of plunger 79, produced by the bias (the spring force) of the second coil spring 81d, the clearance between the rotating cam 70 and the other end of swing arm 71 and the clearance between the other end of swing arm 71 and the associated valve stem end of intake valve 1 are adjusted to zero clearance (zero valve lash).

All the #1-cylinder hydraulic lash adjusters 72, 72 and the #2-cylinder hydraulic lash adjusters 75, 75 have the zero-lash-adjusting function as discussed previously.

As previously discussed, intake-side cylinder cutoff mechanism 5 and exhaust-side cylinder cutoff mechanism 6 are similar to each other in construction. Hence, only the construction of intake-side cylinder cutoff mechanism 5 is hereunder described in detail. Intake-side cylinder cutoff mechanism 5 is provided only on the side of the #1-cylinder hydraulic lash adjusters 72, 72. Intake-side cylinder cutoff mechanism 5 is comprised of a pair of sliding bores (close-fitting bores) 90, 90 of the lash-adjuster bodies 76, 76, a pair of lost-motion springs 91, 91, and a pair of motion-restriction mechanisms 92, 92. Each sliding bore (close-fitting bore) 90 is formed at the bottom of the retaining hole 01a of cylinder head 01 and configured to be continuous with the inner peripheral wall of the lowermost end of the retaining hole 01a. Each lost-motion spring 91 is disposed between the bottom face of sliding bore 90 and the underside of lash-adjuster body 76 under preload for biasing the hydraulic lash adjuster 72 upward. Each motion-restriction mechanism 92 is provided for restricting lost motion of the hydraulic lash adjuster 72. By the way, intake-side cylinder cutoff mechanism 5 is not provided on the side of the #2-cylinder hydraulic lash adjusters 75, 75. Hence, the #2-cylinder hydraulic lash adjuster pair 75, 75 has not any cylinder cutoff function. That is, the #2-cylinder hydraulic lash adjuster pair 75, 75 has only the pivot function and the zero-lash-adjusting function.

The inside diameter of each sliding bore (close-fitting bore) 90 is dimensioned to be identical to the inside diameter of retaining hole 01a. The sliding bore (close-fitting bore) 90 is configured to be continuous with the inner peripheral wall of the lowermost end of the retaining hole 01a, so as to permit the lash-adjuster body 76 to vertically smoothly slide continuously from the retaining hole 01a.

Each lost-motion spring 91 is constructed by a coiled compression spring, which biases the bottom face of lash-adjuster body 76 upward so as to permit the bullet-shaped head 79b of plunger 79 to be kept in elastic-contact with the semi-spherical recessed portion of the underside of the one end of swing arm 71.

By the way, the maximum upward movement of lash-adjuster body 76 is restricted by means of a stopper pin 99, which is fitted into an elongated bore formed in the cylinder head 01. The elongated bore is configured to extend perpendicularly to the axis of the cylindrical retaining hole 01a (or the axis of lash-adjuster body 76) in such a manner as to face the retaining hole 01a (exactly, the first annular recessed groove 76a of lash-adjuster body 76). As clearly seen from the cross sections of FIGS. 15A-15B, the tip 99a of stopper pin 99 is kept in sliding-contact with the wall surface of the first annular recessed groove 76a. When the tip 99a is brought into abutted-engagement with the beveled edge of the lowermost end of the first annular recessed groove 76a owing to the upward movement of lash-adjuster body 76, the maximum upward axial position of the sliding lash-adjuster body 76 is restricted.

Therefore, each hydraulic lash adjuster 72 (exactly, each lash-adjuster body 76) strokes or moves upward and downward between the retaining hole 01a and the sliding bore 90 by the spring force of lost-motion spring 91 in accordance with a rocking motion of swing arm 71, so as to provide lost motion. As a result, the pivot function of the #1-cylinder hydraulic lash adjuster pair 72, 72 (serving as a fulcrum of rocking motion of each swing arm 71) is lost. Accordingly, the action of valve-lifting of each rotating cam 70 is absorbed, and thus opening and closing motions of each intake valve 1 are stopped, thereby enabling the #1-cylinder to be brought into a cylinder cutoff mode (or an inactive cylinder mode).

Each motion-restriction mechanism 92 is mainly comprised of a sliding-pin bore (a radial through hole) 93, a motion-restriction bore 94, a retainer 95, a motion-restricting pin 96, and a return spring 97. Sliding-pin bore 93 is formed in the bottom of lash-adjuster body 76. Motion-restriction bore 94 is formed in the cylinder head 01 and configured to extend perpendicularly to the axis of the cylindrical retaining hole 01a. Retainer 95 is fixedly installed or press-fitted into one end (the leftmost end, viewing FIGS. 15A-15B) of sliding-pin bore 93. Motion-restricting pin 96 is slidably installed in the right-hand side of sliding-pin bore 93 in such a manner as to be movable (slidable) over both the sliding-pin bore 93 and the motion-restriction bore 94. Return spring 97 is disposed between the back end of motion-restricting pin 96 and the retainer 95 under preload for biasing the motion-restricting pin 96 toward the motion-restriction bore 94.

Motion-restriction bore 94 is configured such that, under a specific condition where the maximum upward movement of lash-adjuster body 76 has been restricted by means of the stopper pin 99, the motion-restriction bore 94 conforms closely to the sliding-pin bore 93 in the radial direction so as to permit the top end of motion-restricting pin 96 to be brought into engagement with the motion-restriction bore 94. The inside diameter of motion-restriction bore 94 is dimensioned to be approximately equal to the inside diameter of sliding-pin bore 93. Also, the bottom end of motion-restriction bore 94 is configured to open into a working-fluid passage hole 98, which is formed in the cylinder head 01 and through which a signal pressure can be introduced into the motion-restriction bore 94.

Retainer 95 is a cylindrical member having a cylindrical bore closed at its bottom end (the leftmost end, viewing FIGS. 15A-15B). The bottom end of retainer 95 has a breathing hole (a through hole) 95a formed therein for ensuring a smooth sliding motion of motion-restricting pin 96. As best seen in FIG. 15B, the axial length of retainer 95 is dimensioned such that, when the motion-restricting pin 96 has been completely accommodated in the sliding-pin bore 93, the back end of motion-restricting pin 96 is brought into abutted-engagement with the top end (the rightmost annular end face, viewing FIG. 15B) of retainer 95 so as to restrict a further backward movement (a further retreating movement) of motion-restricting pin 96.

Motion-restricting pin 96 is a cylindrical member having a cylindrical bore closed at its top end. The top end of motion-restricting pin 96 is formed as a cylindrical solid portion. The outside diameter of motion-restricting pin 96 is dimensioned to be slightly less than the inside diameter of each of sliding-pin bore 93 and motion-restriction bore 94, for a smooth slidability of motion-restricting pin. Also, the tip 96a of motion-restricting pin 96 is formed as a pressure-receiving flat end face that receives a hydraulic pressure (a signal pressure) delivered from the working-fluid passage hole 98 to the motion-restriction bore 94. When the hydraulic pressure is applied to the pressure-receiving flat end face of the tip 96a, a retreating movement of motion-restricting pin 96 against the spring force of return spring 97 occurs. Hence, the top end of motion-restricting pin 96 is brought out of engagement with the motion-restriction bore 94, and as a result the motion-restricting pin 96 becomes completely accommodated in the sliding-pin bore 93. In this manner, motion-restriction becomes released and thus lost motion becomes established.

The previously-discussed working-fluid passage hole 98 is configured such that part of hydraulic pressure force-fed or discharged from the oil pump 20 (see FIG. 1) is delivered through the cylinder cutoff switching valve 22 into the working-fluid passage hole 98 (that is, the motion-restriction bore 94) as a signal pressure.

The operating mode of cylinder cutoff switching valve 22 is determined or switched depending on whether a control current from controller 24 is kept high (ON or energized) or low (OFF or de-energized). When cylinder cutoff switching valve 22 is energized (ON), fluid-communication between the discharge passage 20a and the working-fluid passage hole 98 is established but fluid-communication between the discharge passage 20a and the drain passage 23 is blocked, and thus the signal pressure, delivered through the working-fluid passage hole 98 into the motion-restriction bore 94, becomes high. As a result, the hydraulic lash adjuster pair 72, 72 is placed into a lost-motion mode (i.e., a cylinder cutoff mode or an inactive valve mode). Conversely when cylinder cutoff switching valve 22 is de-energized (OFF), fluid-communication between the discharge passage 20a and the working-fluid passage hole 98 is blocked but fluid-communication between the discharge passage 20a and the drain passage 23 is established, and thus the signal pressure, delivered through the working-fluid passage hole 98 into the motion-restriction bore 94, becomes low. As a result, the hydraulic lash adjuster pair 72, 72 is switched to a working valve mode (i.e., an active valve mode).

As set forth above, in a similar manner to the first embodiment, each of intake-side cylinder cutoff mechanism 5 and exhaust-side cylinder cutoff mechanism 6 of the VVA apparatus of the fifth embodiment is operated in either a valve-stopped mode (i.e., an inactive valve mode, in other words, a cylinder cutoff mode) or a working valve mode (i.e., an active valve mode) responsively to a control current from controller 24, which is selected from a high (ON) current value and a low (OFF) current value depending on the detected engine operating condition. That is, in the default mode (i.e., in the signal-pressure OFF mode), the VVA system of the fifth embodiment is configured to be placed into a mechanically stable operating mode (in other words, a mechanical fail-safe operating mode) at which the #1-cylinder intake valves 1, 1 associated with intake-side cylinder cutoff mechanism 5 are mechanically held in their middle valve lift characteristic modes (i.e., L_{I}3), while the #1-cylinder exhaust valves 3, 3 associated with exhaust-side cylinder cutoff mechanism 6 are mechanically held in their middle valve lift characteristic modes (i.e., L_{E}1).

By the way, the previously-discussed intake-side variable valve lift (VVL) mechanism 7 of the #2-cylinder is similar to a continuously variable valve event and lift control (VEL) mechanism as disclosed in Japanese Patent Publication No. 4931740, corresponding to Japanese Patent Provisional Publication No. 2009-030584, in basic construction. The construction of intake-side variable valve lift (VVL) mechanism 7 is hereunder described briefly in reference to FIG. 14. As seen from the perspective view of FIG. 14, the VVL mechanism 7 is comprised of a cylindrical drive cam 100, the rockable cams 73, 73, a motion-transmission mechanism, and a continuously variable working angle and valve lift control mechanism. Drive cam 100 is fixedly connected onto the outer periphery of intake camshaft 8 and arranged on the #2-cylinder side. Rockable cams 73, 73 are rockably supported on the outer peripheral surface of intake camshaft 8 for opening (opening and closing) the #2-cylinder intake valves 2, 2 via the respective swing arms 74, 74. The motion-transmission mechanism is provided for converting rotary motion (torque) of drive cam 100 into oscillating motion (oscillating force) and for transmitting the oscillating motion to the rockable cams 73, 73. The continuously variable working angle and valve lift control mechanism is provided for controlling a working angle as well as a valve lift amount of each of intake valves 2, 2 via the motion-transmission mechanism.

The motion-transmission mechanism is comprised of a rocker arm 101 arranged above the intake camshaft 8, a link arm 102 configured to mechanically linking one end of rocker arm 101 to the drive cam 100, and a link rod 103 configured to the other end of rocker arm 101 to one of rockable cams 73, 73.

The continuously variable working angle and valve lift control mechanism is comprised of a control shaft 104, a control cam 105, and an actuator (not shown). Control shaft 104 is arranged above the intake camshaft 8 and rotatably supported by means of bearings. Control cam 105 is fixedly connected onto the outer periphery of control shaft 104 and slidably fitted into a support bore of rocker arm 101. The actuator (not shown) is provided for controlling a rotation angle of control shaft 104 depending on an engine operating condition.

The left-hand side of control shaft 104 is formed integral with a substantially sector stopper portion 106 for restricting both a maximum rotational position (an actuated position described later) of control shaft 104 in one rotation direction and a maximum rotational position (an unactuated position described later) of control shaft 104 in the opposite rotation direction, corresponding to the rotation direction indicated by the arrow in FIG. 14. One circumferential end face 106a of the sector stopper portion 106 is configured to be brought into abutted-engagement with one of two stopper surfaces (not shown) provided on the cylinder head 01. The other circumferential end face 106b of the sector stopper portion 106 is configured to be brought into abutted-engagement with the other of the two stopper surfaces (not shown) of the cylinder head 01. Stopper 106 is configured such that the valve lift characteristic of each of intake valves 2, 2 is controlled to a small valve-lift characteristic of a given small valve lift L_{I}1 at the rotational position (actuated position) of control shaft 104 at which the one circumferential end face 106a is kept in abutted-engagement with the one stopper surface of cylinder head 01. Also, stopper 106 is configured such that the valve lift characteristic of each of intake valves 2, 2 is controlled to a middle valve-lift characteristic of a given middle valve lift L_{I}2 at the rotational position (unactuated position) of control shaft 104 at which the other circumferential end face 106b is kept in abutted-engagement with the other stopper surface of cylinder head 01.

A biasing mechanism 107 is provided at the left-hand axial end of control shaft 104, further extending leftward from the stopper portion 106, for biasing the control shaft 104 in the previously-discussed rotation direction (unactuated position) indicated by the arrow in FIG. 14 such that the valve lift characteristic of each of intake valves 2, 2 is controlled to the middle valve-lift characteristic of the given middle valve lift L_{I}2. Biasing mechanism 107 is comprised of a substantially rectangular cam-connection portion 107a fixedly connected to the left-hand axial end of control shaft 104, and a coil spring 107b (a return spring) for biasing the control shaft 104 via the cam-connection portion 107a in the rotation direction (toward the spring-return position or unactuated position) indicated by the arrow in FIG. 14 such that the valve lift characteristic of each of intake valves 2, 2 is brought to the middle valve-lift characteristic of the given middle valve lift L_{I}2. As clearly shown in FIG. 14, coil spring 107b is disposed between the upper face of cylinder head 01 and the cam-contour surface of cam-connection portion 107a through a retainer 107c under preload.

With the previously-discussed arrangement, when there is no switching energy (no applied torque) from the actuator to the control shaft 104, the valve lift characteristic of each of intake valves 2, 2 on the #2-cylinder side is stably held in the middle valve-lift characteristic mode of the given middle valve lift L_{I}2 by means of the biasing mechanism 107. The middle valve-lift characteristic mode (i.e., the given middle valve lift L_{I}2), created by the biasing mechanism 107 incorporated in the VVA apparatus of the fifth embodiment, corresponds to the same default mode as the VVA apparatus of the first embodiment.

By the way, the actuator for switching the angular position of control shaft 104 may be an electric-motor driven actuator that motor torque produced by electric current serves as switching energy for mode-switching/conversion or a hydraulic-motor driven actuator that motor torque produced by hydraulic pressure serves as switching energy for mode-switching/conversion.

As discussed above, the VVL mechanism of the VVA apparatus of the fifth embodiment is configured to enable switching of a valve lift amount of each of the #2-cylinder intake valves 2, 2, which are always working, in a stepwise fashion (in two stages in the fifth embodiment) between the given small valve lift amount L_{I}1 and the given middle valve lift amount L_{I}2, in a mode-transition of the #1-cylinder to the cylinder cutoff mode. Hence, the VVA apparatus of the fifth embodiment can provide the same fuel-consumption reducing effect as the first embodiment. Additionally, the VVL mechanism 7 of the VVA apparatus of the fifth embodiment is constructed by the continuously variable working angle and valve lift control mechanism that enables a continuous change in the valve lift amount under a transient mode-switching/conversion state, without rapidly discontinuously switching or changing the valve lift amount of each of the #2-cylinder intake valve 2, 2 between the given small valve lift amount L_{I}1 and the given middle valve lift amount L_{I}2. This contributes to the improved torque-shock suppression effect.

In the fifth embodiment (see FIGS. 14 and 15A-15B), the VVL mechanism is installed on only the side of #2-cylinder intake valves 2, 2. In order to more greatly improve fuel economy, as a modified VVA apparatus of the fifth embodiment, such a VVL mechanism may be further installed on the side of #2-cylinder exhaust valves 4, 4 in the same manner as the third embodiment.

### Sixth Embodiment

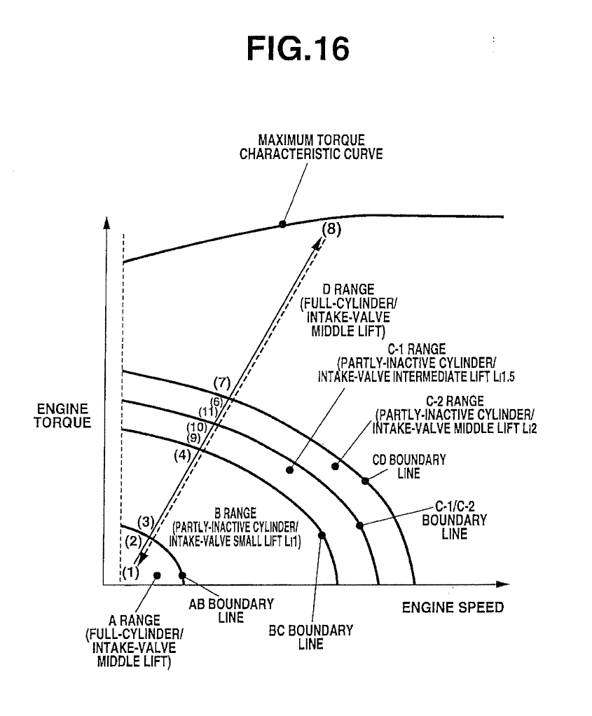

Referring now to FIG. 16, there is shown the VVA system control map of the sixth embodiment showing how the number of working (active) engine cylinders and valve lift characteristics have to be varied with respect to a change in engine operating condition. In the case of the VVA apparatus of the first embodiment, the partly-inactive cylinder operating range is classified into two different operating ranges, namely, the “B” range in which each of the #2-cylinder intake valves 2, 2, which are always working, is operated at the small valve-lift characteristic of the given small valve lift L_{I}1 and the “C” range in which each of the #2-cylinder intake valves 2, 2 is operated at the middle valve-lift characteristic of the given middle valve lift L_{I}2. The sixth embodiment is slightly different from the first embodiment in that the “C” range is further classified into a “C-1” range and a “C-2” range. In the “C-2” range of the sixth embodiment, in the same manner as the “C” range of the first embodiment, each of the #2-cylinder intake valves 2, 2 is operated at the middle valve-lift characteristic of the given middle valve lift amount L_{I}2. Notice that, in the “C-1” range of the sixth embodiment, each of the #2-cylinder intake valves 2, 2 is operated at an intermediate valve-lift characteristic of a given intermediate valve lift amount L_{I}1.5 midway between the given small valve lift L_{I}1 and the given middle valve lift amount L_{I}2.

That is, the VVL mechanism of the VVA apparatus of the sixth embodiment is configured to enable switching of a valve lift amount of each of the #2-cylinder intake valves 2, 2, which are always working, in a stepwise fashion (in three stages in the sixth embodiment) among the given small valve lift amount L_{I}1, the given intermediate valve lift amount L_{I}1.5, and the given middle valve lift amount L_{I}2.

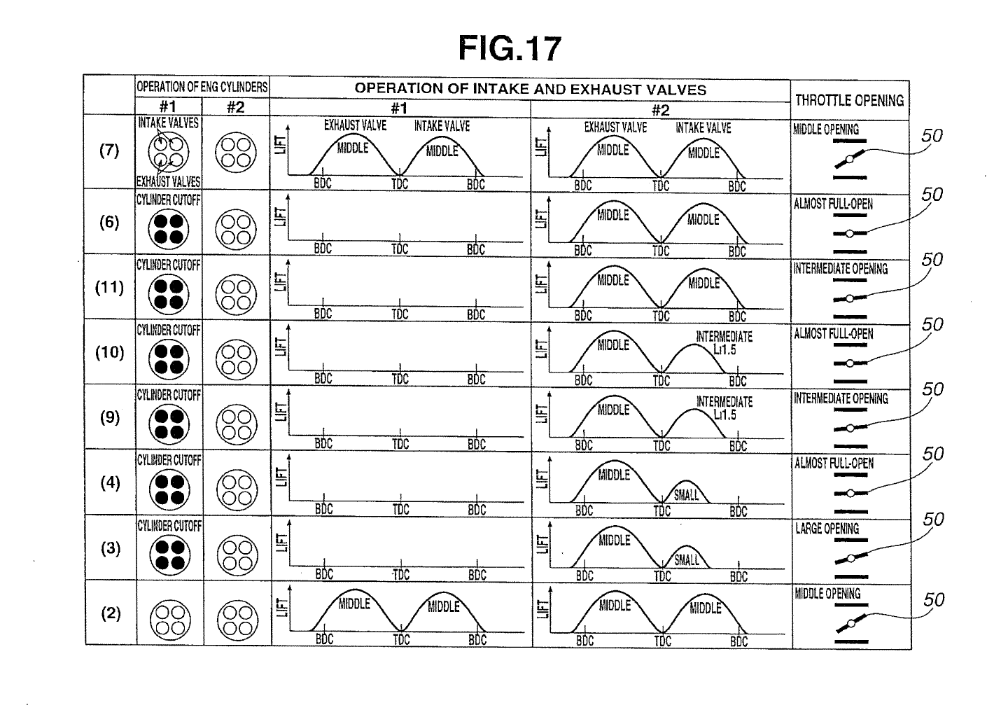

Such a three-stage VVL mechanism has been disclosed in Japanese Patent Provisional Publication No. 2002-256832, corresponding to U.S. Pat. No. 6,550,437 (for instance, see FIGS. 16-17 of U.S. Pat. No. 6,550,437). The three-stage VVL mechanism of U.S. Pat. No. 6,550,437 has three different cams, that is, a small-lift cam (a low-velocity cam) in sliding-contact with a main rocker arm, an intermediate lift cam (a medium-velocity cam) in sliding-contact with a center sub-rocker arm, and a middle-lift cam (a high-velocity cam) in sliding-contact with a side sub-rocker arm. With these sub-rocker arms put in lost motion, each of the #2-cylinder intake valves 2, 2 is operated in the small valve-lift characteristic mode (i.e., the given small valve lift amount L_{I}1) by means of a cam profile of the small-lift cam. When the center sub-rocker arm becomes fixed to the main rocker arm by a first signal-pressure control for a variable lift switching valve, each of the #2-cylinder intake valves 2, 2 is operated in the intermediate valve-lift characteristic mode (i.e., the given intermediate valve lift amount L_{I}1.5) by means of a cam profile of the intermediate lift cam. Furthermore, when the side sub-rocker arm becomes fixed to the main rocker arm by a second signal-pressure control for another variable lift switching valve, each of the #2-cylinder intake valves 2, 2 is operated in the middle valve-lift characteristic mode (i.e., the given middle valve lift amount L_{I}2) by means of a cam profile of the middle-lift cam.

Referring to FIG. 17, there is shown the characteristic diagram corresponding to various operating conditions of the control map of FIG. 16 and illustrating valve lift characteristics and throttle-valve opening characteristics in a full-cylinder operating mode and in a partly-inactive cylinder operating mode in the sixth embodiment. As compared to the characteristic diagram of FIG. 5 illustrating valve lift characteristics and throttle-valve opening characteristics in the first embodiment, the valve lift characteristics and throttle-valve opening characteristics of the operating conditions (1) to (4) and the operating conditions (6) to (8) are the same for both the first embodiment and the sixth embodiment. The sixth embodiment differs from the first embodiment in that, in the sixth embodiment new operating conditions (9) to (11) are added between the operating condition (4) and the operating condition (6).

When the operating condition (4) has been reached under a condition where each of the #2-cylinder intake valves 2, 2, which are always working, is operated in the small valve-lift characteristic mode (i.e., the given small valve lift amount L_{I}1) during the partly-inactive cylinder operating mode, the opening of throttle valve 50 becomes an almost full-open state, and thus its top (the uppermost limit) of the engine torque becomes reached. Immediately when the engine operating condition exceeds the “BC” boundary line of the “B” range and “C” range (exactly, the “C-1” range), for the purpose of further increasing the engine torque, the valve lift amount of each of the #2-cylinder intake valves 2, 2 has to be increased.

Hereupon, suppose that each of the #2-cylinder intake valves 2, 2 is converted from the small valve-lift characteristic mode (i.e., the given small valve lift amount L_{I}1) to the middle valve-lift characteristic mode (i.e., the given middle valve lift amount L_{I}2) as discussed previously in relation to the VVA apparatus of the first embodiment. In such a case, to suppress an increase in engine torque, the opening of throttle valve 50 becomes controlled to a large opening, which is throttled or narrowed slightly from the almost full-open throttle. The controlled throttle opening (that is, the large opening) is somewhat suppressed as compared to the almost full-open throttle, and as a result some pumping loss takes place.

In contrast to the above, in the VVA apparatus of the sixth embodiment, each of the #2-cylinder intake valves 2, 2 is converted from the small valve-lift characteristic mode (i.e., the given small valve lift amount L_{I}1) to the intermediate valve-lift characteristic mode (i.e., the given intermediate valve lift amount L_{I}1.5 defined by the inequality L_{I}1<L_{I}1.5<L_{I}2) (see the middle-to-intermediate intake-valve lift characteristic conversion (L_{I}1→L_{I}1.5) during the transition from the operating condition (4) to the operating condition (9) in FIG. 17). Hence, the charging efficiency tends to somewhat decrease, and thus the opening of throttle opening 50 is corrected to an intermediate opening (midway between a large opening and an almost full-open throttle) depending on the somewhat decreased charging efficiency, so as to maintain the engine torque. By virtue of the opening of throttle opening 50 increased to the intermediate opening, in the “C-1” range it is possible to more greatly reduce the pumping loss, thereby more greatly improving fuel economy.

Subsequently to the above, when the accelerator pedal is further depressed from the operating condition (9) of the control map of FIG. 16 and the characteristic diagram of FIG. 17, engine speed and engine torque further increase. During changing operating conditions from the operating condition (9) to the operating condition (10) in the characteristic diagram of FIG. 16, the opening of throttle valve 50 is increased from the intermediate opening (midway between the large opening and the almost full-open throttle) to the almost full-throttle. Thus, on the operating condition (10) its top (the uppermost limit) of the engine torque becomes reached. Immediately when the engine operating condition exceeds the “C-1/C-2” boundary line of the “C-1” range and “C-2” range, on the operating condition (11) the lift characteristic of each of the #2-cylinder intake valves 2, 2 is converted and increased to the given middle valve lift L_{I}2. The changing operating conditions (6)-(7) subsequently to the operating condition (11) are the same as the first embodiment.

As discussed above, in the sixth embodiment, the “C-1” range, in which each of the #2-cylinder intake valves 2, 2 is operated at the intermediate valve-lift characteristic of the given intermediate valve lift amount L_{I}1.5 defined by the inequality L_{I}1<L_{I}1.5<L_{I}2, is provided between the “B” range and the “C-2” range substantially corresponding to the “C” range. This contributes to the more greatly improved fuel economy.

It will be appreciated that the invention is not limited to the particular embodiments shown and described herein, but that various changes and modifications may be made. As described previously, in the first embodiment, as an intake-side cylinder cutoff mechanism and an exhaust-side cylinder cutoff mechanism, a working-cam switching type that enables switching between middle-lift cam 9 and zero-lift cams 10, 10 is used. Also, in the fifth embodiment, as an intake-side cylinder cutoff mechanism and an exhaust-side cylinder cutoff mechanism, a hydraulic-lash-adjuster equipped lost-motion type that enables switching between a locked lash-adjuster-body state having a pivot function and a lash-adjuster-body lost-motion state wherein the pivot function is lost is used. As an intake-side cylinder cutoff mechanism and an exhaust-side cylinder cutoff mechanism, the working-cam switching type and the hydraulic-lash-adjuster equipped lost-motion type either alone or in combination may be used.

Additionally, in the first embodiment, as a variable valve lift (VVL) mechanism, a working-cam switching type that enables switching between middle-lift cam 25 and small-lift cams 26, 26 is used. Also, in the fifth embodiment, a rockable-cam type, which is configured to continuously vary a working angle as well as a valve lift by changing an initial position of oscillating motion of each of rockable cams 73, 73 is used. As a variable valve lift (VVL) mechanism, either the working-cam switching type or the rockable-cam type may be appropriately selected.

For instance, in the first embodiment, hydraulic pressure is utilized as switching energy (a source of energy for mode-switching/conversion). In lieu thereof, electrical energy (electricity) or other energy (e.g., negative pressure) may be utilized as a source of energy for mode-switching/conversion.

Furthermore, as described previously, a variable phase control mechanism (i.e., a variable valve timing control (VTC) mechanism) may be added and combined with the variable valve lift (VVL) mechanism.

Moreover, as discussed previously in relation to the VVA apparatus of the sixth embodiment, it is preferable that the VVL mechanism is configured to enable switching of a valve lift amount of each intake valve, which is always working, in three stages for instance among three different valve lifts L_{I}1, L_{I}1.5, and L_{I}2. In the case of valve-lift switching in three or more stages, it is possible to more remarkably improve a fuel-consumption reducing effect during the partly-inactive cylinder operating mode. In switching an intake-valve lift amount in a stepwise fashion (e.g., in two or more stages), a working-cam switching type that enables rapid but discontinuous valve-lift switching/conversion may be used. In lieu thereof, a rockable-cam type that enables continuous valve-lift switching/conversion may be used. The working-cam switching type has the advantage of high valve-lift control accuracy. The rockable-cam type has the advantage of reduction/suppression in torque shock.

The entire contents of Japanese Patent Application No. 2013-248807 (filed Dec. 2, 2013) are incorporated herein by reference.

While the foregoing is a description of the preferred embodiments carried out the invention, it will be understood that the invention is not limited to the particular embodiments shown and described herein, but that various changes and modifications may be made without departing from the scope or spirit of this invention as defined by the following claims.

What is claimed is:

1. A variable valve actuation apparatus for a multi-cylinder internal combustion engine comprising:
a cylinder cutoff mechanism configured to enable a cylinder cutoff mode in which intake and exhaust valves included in one engine-cylinder group of a plurality of engine-cylinder groups are kept inactive; and
an intake-side variable valve lift mechanism configured to enable a valve lift amount of each of intake valves included in the other engine-cylinder group of the plurality of engine-cylinder groups to be switched between a given first intake-valve lift amount and a given second intake-valve lift amount relatively greater than the given first intake-valve lift amount in a stepwise fashion,
wherein the intake-side variable valve lift mechanism is configured to enable the valve lift amount of each of the intake valves of the other engine-cylinder group to be selected from the given first intake-valve lift amount and the given second intake-valve lift amount during the cylinder cutoff mode in which the one engine-cylinder group is kept inactive.

2. A variable valve actuation apparatus for a multi-cylinder internal combustion engine as recited in claim 1, wherein:
the cylinder cutoff mechanism is configured to enable a valve lift amount of each of the intake valves of the one engine-cylinder group to be switched between a zero lift amount and a given third intake-valve lift amount.

3. A variable valve actuation apparatus for a multi-cylinder internal combustion engine as recited in claim 2, wherein:
the intake-side variable valve lift mechanism is configured to operate in a valve lift characteristic mode of the given second intake-valve lift amount relatively greater than the given first intake-valve lift amount, when there is no action of switching energy for switching the valve lift amount of each of the intake valves of the other engine-cylinder group.

4. A variable valve actuation apparatus for a multi-cylinder internal combustion engine as recited in claim 2, wherein:
the intake-side variable valve lift mechanism is configured to operate in a valve lift characteristic mode of the given first intake-valve lift amount relatively less than the given second intake-valve lift amount, when there is no action of switching energy for switching the valve lift amount of each of the intake valves of the other engine-cylinder group.

5. A variable valve actuation apparatus for a multi-cylinder internal combustion engine as recited in claim 2, wherein:
the cylinder cutoff mechanism and the intake-side variable valve lift mechanism are similar to each other in construction, but cam profiles, which are contoured to drive each of the intake valves associated with the cylinder cutoff mechanism and each of the intake valves associated with the intake-side variable valve lift mechanism, differ from each other.

6. A controller for a variable valve actuation apparatus for a multi-cylinder internal combustion engine, comprising:
an input-and-output interface section configured to receive sensor signals for determining an engine operating condition; and
a control section configured to:
control, depending on the engine operating condition, operation of a cylinder cutoff mechanism that enables a cylinder cutoff mode in which intake and exhaust valves included in one engine-cylinder group of a plurality of engine-cylinder groups are kept inactive, and
control, depending on the engine operating condition, operation of an intake-side variable valve lift mechanism that enables a valve lift amount of each of intake valves included in the other engine-cylinder group of the plurality of engine-cylinder groups to be switched between a given first intake-valve lift amount and a given second intake-valve lift amount relatively greater than the given first intake-valve lift amount in a stepwise fashion,
wherein the controller is configured to generate a control current for selectively switching between the given first intake-valve lift amount and the given second intake-valve lift amount via the intake-side variable valve lift mechanism, during the cylinder cutoff mode in which the one engine-cylinder group is kept inactive.

7. A variable valve actuation apparatus for a multi-cylinder internal combustion engine as recited in claim 1, further comprising:
an exhaust-side variable valve lift mechanism configured to enable a valve lift amount of each of exhaust valves included in the other engine-cylinder group to be switched between a given first exhaust-valve lift amount and a given second exhaust-valve lift amount relatively greater than the given first exhaust-valve lift amount in a stepwise fashion,
wherein the valve lift amount of each of the exhaust valves of the other engine-cylinder group is switched between the given first exhaust-valve lift amount and the given second exhaust-valve lift amount via the exhaust-side variable valve lift mechanism, when switching the valve lift amount of each of the intake valves of the other engine-cylinder group between the given first intake-valve lift amount and the given second intake-valve lift amount via the intake-side variable valve lift mechanism.

8. A variable valve actuation apparatus for a multi-cylinder internal combustion engine as recited in claim 2, wherein:
when the one engine-cylinder group is placed into the cylinder cutoff mode via the cylinder cutoff mechanism, mode-switching to the cylinder cutoff mode is initiated after the valve lift amount of each of the intake valves of the other engine-cylinder group has been switched between the given first intake-valve lift amount and the given second intake-valve lift amount via the intake-side variable valve lift mechanism.

9. A variable valve actuation apparatus for a multi-cylinder internal combustion engine as recited in claim 3, wherein:
when the one engine-cylinder group is placed into the cylinder cutoff mode via the cylinder cutoff mechanism, mode-switching to the cylinder cutoff mode is initiated after the valve lift amount of each of the intake valves of the other engine-cylinder group has been switched from the given second intake-valve lift amount to the given first intake-valve lift amount via the intake-side variable valve lift mechanism.

10. A variable valve actuation apparatus for a multi-cylinder internal combustion engine as recited in claim 4, wherein:
when the one engine-cylinder group is placed into the cylinder cutoff mode via the cylinder cutoff mechanism, mode-switching to the cylinder cutoff mode is initiated after the valve lift amount of each of the intake valves of the other engine-cylinder group has been switched from the given first intake-valve lift amount to the given second intake-valve lift amount via the intake-side variable valve lift mechanism.

11. A variable valve actuation apparatus for a multi-cylinder internal combustion engine as recited in claim 9, wherein:
during an engine startup period, the cylinder cutoff mechanism is operated in a full-cylinder operating mode that the one engine-cylinder group and the other engine-cylinder group are both kept active.

12. A variable valve actuation apparatus for a multi-cylinder internal combustion engine as recited in claim 3, wherein:
the intake-side variable valve lift mechanism is hydraulically operated, and the switching energy is a hydraulic pressure supplied to the intake-side variable valve lift mechanism.

13. A variable valve actuation apparatus for a multi-cylinder internal combustion engine as recited in claim 3, wherein:
the intake-side variable valve lift mechanism is electrically operated, and the switching energy is an electric current supplied to the intake-side variable valve lift mechanism.

14. A variable valve actuation apparatus for a multi-cylinder internal combustion engine as recited in claim 3, wherein:
the given second intake-valve lift amount and the given third intake-valve lift amount are set to be identical to each other.

15. A variable valve actuation apparatus for a multi-cylinder internal combustion engine as recited in claim 4, wherein:
the given first intake-valve lift amount and the given third intake-valve lift amount are set to be identical to each other.
